(19) United States
(12) Patent Application Publication
(10) Pub. No.: US 2015/0006393 A1
(43) Pub. Date: Jan. 1, 2015

(54) ACCELERATED PAYMENT SYSTEM FOR CONSTRUCTION PROJECTS

(71) Applicant: Textura Corporation, Deerfield, IL (US)

(72) Inventors: Patrick J. Allin, Lake Bluff, IL (US); John W. Smith, Grayslake, IL (US); Franco Turrinelli, Chicago, IL (US)

(73) Assignee: TEXTURA CORPORATION, Deerfield, IL (US)

(21) Appl. No.: 14/317,914

(22) Filed: Jun. 27, 2014

Related U.S. Application Data
(60) Provisional application No. 61/840,194, filed on Jun. 27, 2013.

(51) Int. Cl. G06Q 20/40

(52) U.S. Cl. CPC G06Q 20/40
USPC 705/44

(57) ABSTRACT

Systems and methods are provided for processing accelerated payments, associated with a construction project, that are funded through a third-party funding source. The server is configured to receive, from a first participant associated with the construction project, a request for a payment for services or materials provided in connection with the construction project, the request for payment including a requested payment amount. The server also receives an approval of the request for payment based on a review of a first project metric. An accelerated payment instruction is then transmitted to the third-party funding source and a second project metric is made available to the funding source to aid their review of whether to approve funding. A funding approval is then received from the third-party funding source confirming that an accelerated payment for the requested payment amount will be funded by the third-party funding source.

### RELATED APPLICATIONS

This application claims the benefit of U.S. Provisional Patent Application No. 61/840,194, filed Jun. 27, 2013, the entire contents of which are incorporated herein by reference.

### BACKGROUND

The present invention relates to systems and methods for accelerating payments to contractors and material suppliers, relative to a normal payment workflow, during the course of a hierarchically organized construction project.

### SUMMARY

As a result of the increased certainty provided by the technological implementation described herein, General Contractors and third-party Funding Organizations can extend payments to the Subcontractor on an accelerated timeline relative to a normal payment schedule. For example, in “pay-when-paid” arrangements, the system allows for payments to Subcontractors to be made before payments are received from the Project Owner. Furthermore, as again described further below, the construction project funding system provides regulated access to select project source data and project summary data to allow the General Contractor and the Funding Organization to manually verify project metrics prior to approving and initiating an accelerated payment to a Subcontractor. This project data is accessed from the same system that provides for the budget reconciliation and invoice certainty noted above, but is provided without compromising the confidentiality of other project data maintained on the server.

Moreover, by interacting with data stored on a Subcontractor prequalification database, the construction project funding system can provide a General Contractor and a Funding Organization with source data, self-reported Subcontractor data, and independent review/reporting data regarding the practices and capabilities of the Subcontractor. This information is readily available on the system described herein, but is not readily accessible from any publicly available source. As such, the construction project funding system allows a Funding Organization and a General Contractor to make informed decisions based on routinely updated information without the delay and possibility of tampering associated with collecting that information from the Subcontractor directly.

In one embodiment, the invention provides a construction project funding system comprising a networked computer server for processing accelerated payments, associated with a construction project, that are funded through a third-party funding source. The server is configured to receive, from a first participant associated with the construction project, a request for a payment for services or materials provided in connection with the construction project, the request for payment including a requested payment amount. The server also receives an approval of the request for payment based on a review of a first project metric. An instruction is then transmitted to the third-party funding source to make a payment that is accelerated relative to a usual payment schedule and a second project metric is made available to the funding source to aid their review of whether to approve funding. A funding approval is then received from the third-party funding source confirming that an accelerated payment for the requested payment amount will be funded by the third-party funding source.

In some embodiments, the request for payment is created by a construction payment management system that verifies that the requested payment amount corresponds to work performed or materials provided by the first participant. In some embodiments, the construction payment management system is configured to automatically generate the request for payment based on project budget information stored on the construction payment management system. In some embodiments, the construction payment management system prevents the first participant from creating a request for payment if the first participant is not in compliance with contractual obligations.

In some embodiments, the first metric and the second metric are derived from at least one of project source data, project summary data, self-reported Subcontractor data, and review/categorization information provided by a third-party. The first and second project metrics can be made available through the construction payment management system, a dedicated accelerated payment system, or through the construction project funding system.

In another embodiment the invention provides a construction project funding system comprising a networked computer server for processing accelerated payments associated with a construction project that are funded through a third-party funding source. The server is configured to receive, from a first participant associated with the construction project, a request for a payment for services or materials provided in connection with the construction project, the request for payment including a requested payment amount. The server then receives an approval of the request for payment from a second participant associated with the construction project, wherein the approval is based on a review of a first project metric by the second participant. The approval by the second participant cannot be revoked by the second participant and creates an obligation that the second participant satisfy the request for payment by providing payment to the third-party funding source.

As discussed in further detail below, the construction project funding system provides for functionality that was not previously achievable—either manually or through other computer-based project management systems. In particular, by integrating and automating various operations in a complexly programmed, networked computer environment, the construction project funding system, in some embodiments, ensures that all budget tiers are reconciled for a hierarchically organized construction project. The functionality to generate and submit requests for payment is only made available when the budget tiers are reconciled. Furthermore, the requests for payment can only be generated through the system by selecting a specific material or service from a previously agreed upon and hierarchically reconciled budget. Therefore, General Contractors have technological certainty that a request for payment submitted by a Subcontractor will not be later rejected by a Project Owner for procedural irregularities or a deficiency of required documentation.

Other aspects of the invention will become apparent by consideration of the detailed description and accompanying drawings.

### BRIEF DESCRIPTION OF THE DRAWING

FIG. 1 is a block diagram of a construction project payment and management hierarchy.

FIG. 2 is a block diagram of an accelerated payment system interacting with various other project/payment systems for a construction project.

FIG. 3A is a block diagram of the components of the accelerated payment system of FIG. 2.

FIG. 3B is a block diagram of the components of a networked construction project funding system including the accelerated payment system of FIG. 3A.

FIG. 4 is a flowchart of a method for making payments for work performed in and materials supplied to a construction project using the systems of FIG. 2.

FIG. 5 is a block diagram of a data structure for storing contract line items and corresponding schedule of value amounts for a project contract.

FIG. 6 is a timing diagram illustrating the approval and payment of a request for payment using a “pay-when-paid” mechanism.

FIG. 7 is a timing diagram illustrating the approval and payment of a request for payment using an accelerated payment mechanism funded by a third-party Funding Organization.

FIG. 8 is a flowchart illustrating a method of approving and funding an accelerated payment for a construction project.

FIG. 9 is a relationship diagram for various participants and systems utilizing the accelerated payment system of FIG. 2.

FIG. 10 is a flowchart illustrating a method of creating an accelerated payment program and enrolling contractors in the accelerated payment program.

FIG. 11 is a block diagram of the stored data components of a program definition file for an accelerated payment program implemented by the system of FIG. 2.

FIGS. 12A and 12B are user interfaces for receiving program definition information from a General Contractor.

FIG. 13 is a flowchart illustrating a method of making an accelerated payment to a Subcontractor using the accelerated payment system of FIG. 2.

FIG. 14 is a user interface for creating a request for payment.

FIG. 15 is a user interface for receiving an approval of a request for payment from a General Contractor.

FIG. 16 is a user interface for displaying a request for payment from a Subcontractor to a General Contractor.

FIG. 17 is a user interface for receiving a “Fundable Trigger” from a General Contractor and forwarding one or more requests for payment to a Funding Organization.

FIG. 18A is a user interface for receiving an approval of a request for payment from a Funding Organization.

FIG. 18B is a user interface for displaying batch invoice details accessible from the user interface of FIG. 18A.

FIGS. 19A and 19B are another example of a user interface for displaying project data to a Funding Organization for review.

FIG. 20 is a flowchart of another method for making an accelerated payment to a Subcontractor using the system of FIG. 2.

### DETAILED DESCRIPTION

Before any embodiments of the invention are explained in detail, it is to be understood that the invention is not limited in its application to the details of the system(s) and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium). As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

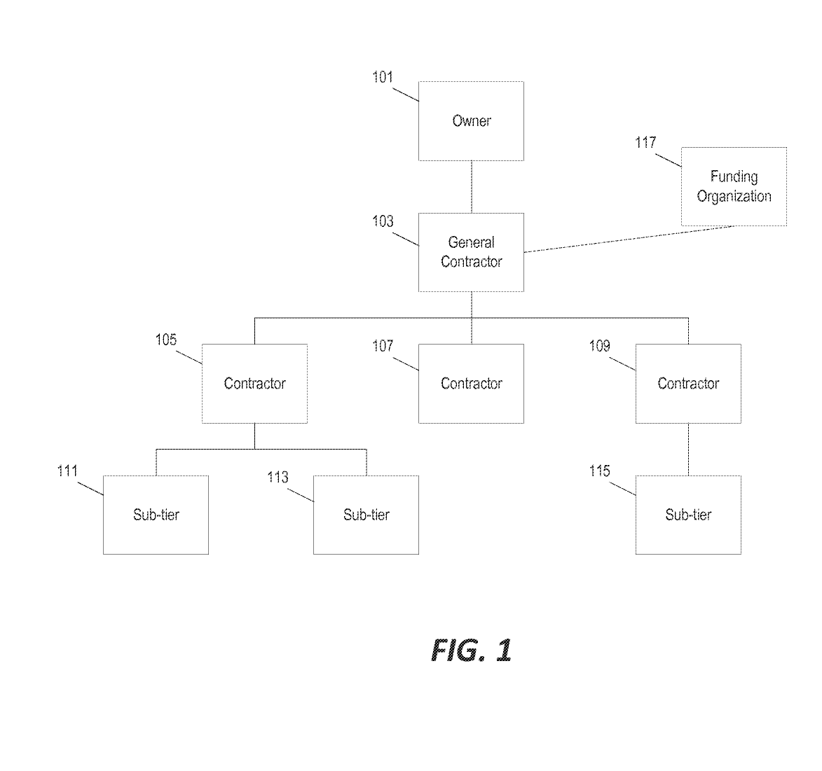

FIG. 1 illustrates an example of a hierarchically organized construction project. The construction project is organized in support of the Owner 101 of the project. The owner (or developer) 101 is typically the entity that ultimately puts the building to use—either by occupying, leasing or selling it). A General Contractor (GC) 103 is contracted to manage the overall construction of the project. The General Contractor 103 also assumes a contractual responsibility for the delivery of the project and, in some cases, may play a role in the construction activities by self-performing some of the required construction. A General Contractor 103 typically has a one-to-many relationship with projects. In other words, a single General Contractor organization may have many concurrent projects that it manages, but each of those projects is typically managed by only a single General Contractor organization. However, in some constructions, projects may be managed by multiple General Contractors performing as a joint venture (JVS) or other combined entity.

The General Contractor 103 will engage one or more contractors 105, 107, 109 to perform various construction specialties or to provide required materials for the project. These contractors (for example, Subcontractors and material suppliers) work under the General Contractor 103 to form a strict contractual hierarchy for the construction project. Each contractor 105, 107, 109 may engage one or more additional contractors (e.g., sub-tier contractors, material suppliers, and vendors), which will provide services, equipment, labor, or materials under contract to the project.

Contractual terms may include contingent payment or other administrative terms that delay payment from the General Contractor 103 to the Subcontractor. For example, hierarchically organized construction projects—such as the one illustrated in FIG. 1—may be conducted under a “Pay-when-paid” clause that is included in each sub-contract. Under a “Pay-when-paid” arrangement, the General Contractor 103 is obligated to release payment to each Subcontractor only after the General Contractor 103 is paid by the owner 101. The Subcontractors are obligated to pay their employees before receiving payment from the General Contractor and may be obligated to pay material suppliers or other sub-tier contractors before receiving payment from the General Contractor. The “Pay-when-paid” arrangement can creates a cash flow challenge from the perspective of the Subcontractor since the Subcontractor is effectively required to finance the work as it is performed and/or the materials as they are delivered while the General Contractor 103 is not obligated to make any payment until funded by the owner.

The system described below provides a computer-based system wherein the General Contractor 103 establishes a funding arrangement with a third-party, external Funding Organization 117 either directly or through an intermediary. In some forms of the system, the intermediary company provides and manages the construction project funding system functionality described herein. By using the construction project funding system, Subcontractors and other sub-tier participants receive payment on a more accelerated timeline from the Funding Organization on behalf of the General Contractor 103. In some forms and arrangements of the system, the Subcontractor is paid at a discounted rate to compensate the Funding Organization 117/General Contractor 103 for providing the payment on an accelerated basis. The General Contractor 103 then pays the Funding Organization 117 at a pre-arranged amount and maturity date (for example, after the General Contractor 103 receives payment from the owner 101). This mechanism mitigates the cash flow challenge faced by Subcontractors while minimizing the impacts on the remaining participants in the hierarchical construction project.

Such a construction project funding system has not here-to-for been practical. The creation within the system of defined workflows as outlined herein that strictly comply with all elements of the hierarchical contractual arrangements and obligations, coupled with access to metrics allowing informed review and approval of invoices and payments at all levels, provides an automated tool to ensure the General Contractor's contractual obligations are satisfied, even while processing accelerated payments to participants in the project; all without incurring increased risk from accelerating such payments.

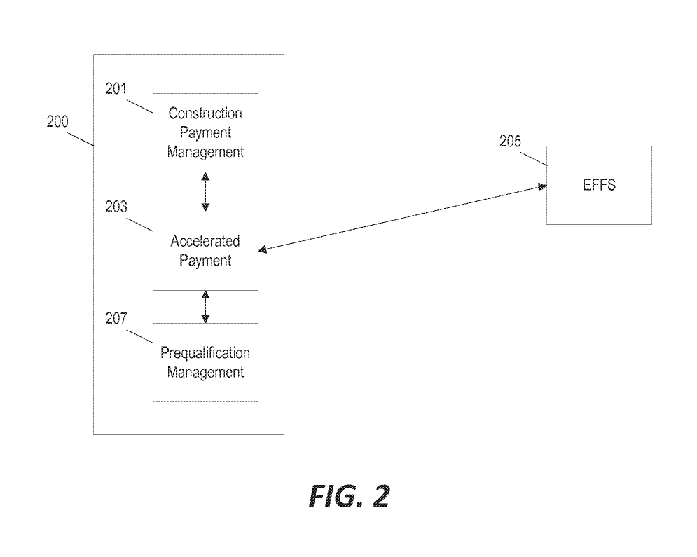

FIG. 2 illustrates an integrated construction project funding system 200 for managing various portions of a construction project process. A construction payment management system 201 receives information from the various participants in the construction project such as, for example, project budgets, payment requests, certification statements, and lien waivers. An example of one such construction payment management system 201 is described in U.S. Patent Publication No. 2012/0191604 (U.S. application Ser. No. 13/440,650), published Jul. 26, 2012, the entire contents of which are incorporated herein by reference.

The construction payment management system 201 can be used as a stand-alone system for tracking and effecting payments to the various participants in the construction project. However, the construction payment management system 201 can also be configured to interact with an external system such as the accelerated payment system 203 to effect the payments on an accelerated basis as described in detail below. When the accelerated payment system 203 is utilized, it can be configured such that it can be accessed by and communicate with an external funding organization source server 205.

The system also includes a prequalification management system 207 that is used to track information for potential Subcontractors and to “qualify” contractors to bid on projects posted by various project owners, General Contractors, etc. An example of one such prequalification system is described in detail in U.S. Publication No. 2010/0153293 (U.S. application Ser. No. 12/636,258), published on Jun. 17, 2010, the entire contents of which are incorporated herein by reference.

In addition to “qualifying” Subcontractors to bid on various projects, the prequalification management system 207 can also be adapted to be used by a General Contractor 103 to determine whether to offer the accelerated payment mechanism to specific Subcontractors and, if so, to determine the terms under which the accelerated payment mechanism will operate. Furthermore, in some forms and arrangements of the system, the prequalification management system 207 may be used by the external Funding Organization 117 to determine whether and/or under what terms to provide funding to the General Contractor 103 for accelerated payments to the Subcontractors and sub-tier participants.

Like the construction payment management system 201 discussed above, the prequalification management system 207 can be implemented as a stand-alone system and can be configured to interact with the accelerated payment system 203 such that the information and evaluation data stored thereon can be accessed by and communicated to the accelerated payment system 203 to be used in determining whether to “qualify” a particular contractor for an accelerated payment program.

However, although the examples discussed herein refer to the three subsystems (i.e., the construction payment management system 201, the accelerated payment system 203, and the prequalification management system 207) separately, the functionality described herein or portions thereof can be implemented in a single construction project funding system. Furthermore, functionality that is described herein as being executed by one specific subsystem (for example, the construction payment management system 201) can be implemented on a different subsystem (e.g., the accelerated payment system 203) unless specifically noted otherwise.

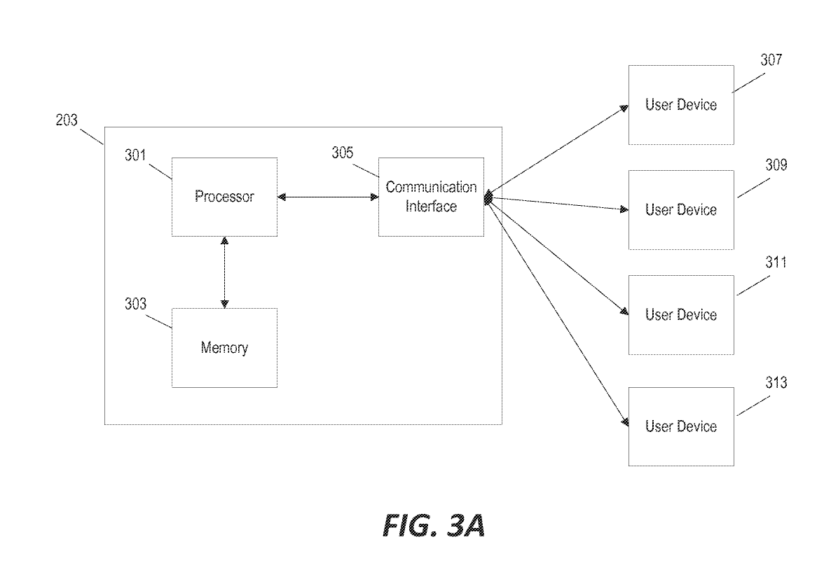

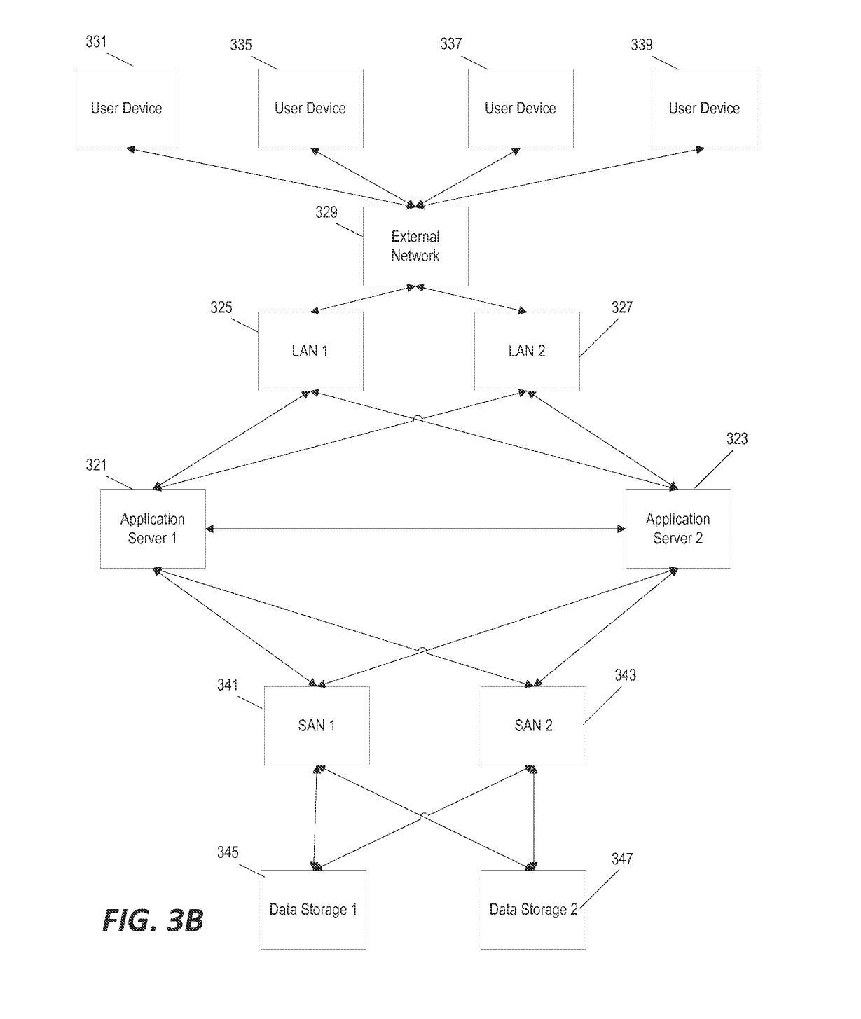

FIG. 3A illustrates the accelerated payment system 203 in further detail. The accelerated payment system includes a processor 301 and memory 303. The memory 303 stores project data (as described in further detail below) and instructions that are executed by the processor 301 to provide the functionality as described herein. The processor 301 also interacts with a communications interface 305 such as a wired or wireless network connection. Through the communication interface 305, the accelerated payment system 203 is accessible by and interacts with a plurality of external user devices 307, 309, 311, and 313. The user devices can be implemented as laptop/desktop personal computers, tablets, smart phones, etc.

In some forms and arrangements, the accelerated payment system 203 is implemented as an Internet-based web server that is accessible by any device with an Internet connection. Furthermore, while the various components of the system as illustrated in FIG. 2 are shown as separate, distinct components, in some forms and arrangements, the various functional features of the system (i.e., the construction payment management system 201, the accelerated payment system 203, and the prequalification management system 207) are implemented as a single web-server. In either embodiment, the servers are specially programmed to perform all of the functions required to achieve the benefits of the accelerated payment system 203 or the integrated construction project funding system 200 as a whole.

FIG. 3B illustrates a networked environment for implementing the accelerated payment system of FIG. 3A or the construction project funding system for FIG. 2. A pair of application servers 321, 323 are accessible to the users and provide the functionality described herein. In this example, the application servers 321, 323 provide redundant functionality and serve to enable more reliable processing of requests and usage from numerous users concurrently. The application servers 321, 323 are connected to two redundant local area networks 325, 327 which work with the application servers 321, 323 to provide load balancing and work queuing. Both local area networks 325, 327 are connected to an external network 329 such as, for example, the Internet or an extranet. User devices 331, 335, 337, 339 access the functionality provided by the servers 321, 323 through the external network.

The application servers 321, 323 are also both connected to two redundant storage area networks 341, 343. The application servers 321, 323 area able to access data stored on a plurality of data storage devices 345, 347 through either of the storage area networks 341, 343. In some embodiments, the multiple data storage devices 345, 347 are redundant and are synchronized on a regular schedule. However, in other forms and arrangements of the system, each data storage device is associated with a different functional component of the construction project funding system. For example, data storage device 345 may store all of the project budget data and invoice generation data associated with the construction payment management system while the data storage device 347 stores the Subcontractor prequalification information associated with the prequalification management system. In such arrangements, an additional data storage device coupled to the storage area networks 341, 343 is provided to store accelerated payment program data associated with the accelerated payment system.

By using multiple redundant application servers and networks (both local area networks and storage area networks), the system is able to implement a single “point of entry” for the user devices to access the system while also properly balancing the loads and work queues. Users and system activity are automatically transferred from one server to another upon failure or overload of the application server. This mechanism maintains transaction and data integrity through shared memory and persisted data. Furthermore, the data stored on the data storage devices is backed up for each component at multiple data center locations such that, in the event of a loss of a data center, service can continue to be provided and the integrity of the data is not compromised.

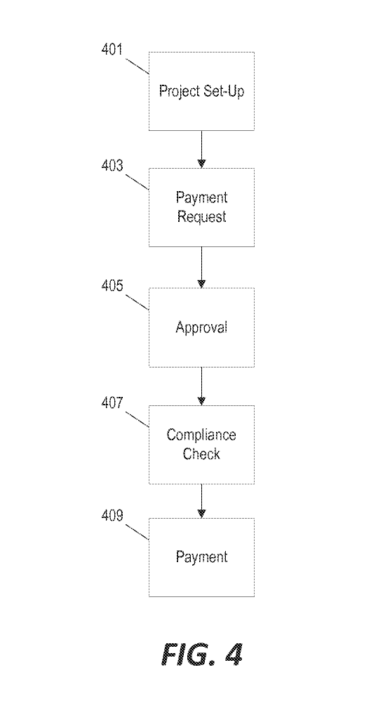

FIG. 4 illustrates a method of using the system of FIGS. 2 and 3 to manage and process payments for a construction project. First, a project owner 101 or General Contractor 103 begins by configuring the project (step 401). The construction project can be defined on the system in a number of different ways including, for example, by the physical address of the construction location, by the scope or contract of the project, or by other logical subdivisions of an ongoing program/series of projects. A contract between the Owner 101 and the General Contractor 103 defines the terms, scope, risk sharing, pricing, and other aspects of the project as they relate to the General Contractor 103.

As contracts are finalized with one or more Subcontractors and material suppliers, the Subcontractor organizations are added and the various specific details of each contract are added to the project management system. These details govern how the system processes payments and provides information to the various participants. In some projects, a single Subcontractor may have multiple contracts within a single project. For example, a Subcontractor company might be contracted separately to provide electrical wiring and telephone/communication systems wiring for the building.

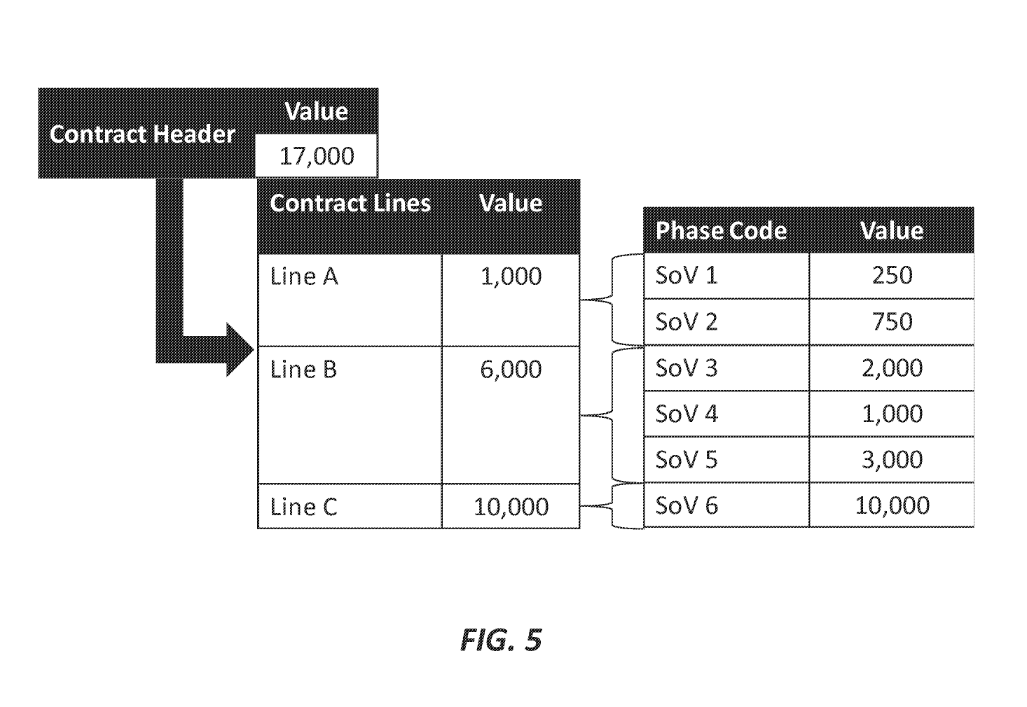

The budget for each contract on the construction project is managed according to the terms of the contract and applicable local laws. In most cases, the contract has a value and that value may be subdivided into multiple contract line items as illustrated in FIG. 5. The system uses the contract line items for tracking different cost codes and cost reporting as well as adding structure to the contract relating to construction phases or other subdivisions of scope (e.g., change orders). Budget line items are then used by the system to provide further detail for each line item. These details are subsidiary to the contract line items and may be referred to as, for example: Schedule of Values items, Phase Codes, Work Breakdown Structure (“WBS”), or Bills of Quantities. The purpose of each budget line item is to document the work performed at a level of detail that supports the requirements of the contract as well as the need to review and approve Requests for Payment. Budgeted (or contracted) values are stated for each line item and the system may ensure that the total of all line items is equal to the total contracted value. Payment Requests processed through the system will include a full Schedule of Values (or Work Breakdown Structure (WBS)) structure and asset quantities. In some forms and arrangements, the system will also provide a percentage of completion for each item.

In the example of FIG. 5, the contract value is $17,000. The contract line items Line A, Line B, and Line C are assigned the value of $1,000, $6,000, and $10,000, respectively. Line item A further includes two budget line items (listed in FIG. 5 as “phase codes”)—SoV1 at $250 and SoV2 at $750. Note that the budget line items for Line A equal the total contract line item value assigned to Line A. Line item B further includes three budget line items—SoV3 at $2,000, SoV4 at $1,000, and SoV5 at $3,000. Again, the value of each budget line item equals the total value of the contract line item (i.e., $6,000). Lastly, Line item C includes only a budget line item—SoV6 at $10,000. Because contract line item C has only one budget line item, the value of the contract line item and the budget line item are the same. Furthermore, it is noted that the value of all three contract line items equal the total cost of the contract value.

In some forms and arrangements, the system will verify that the total cost of the budget line items for each contract line item equals the value assigned to the contract line item. If the values are not equal, the system will prevent the participant from submitting a request for payment. Furthermore, in some constructions, the total value of the contract line items must be exactly equal to the total contract value before a request for payment can be submitted. Because the system is configured to ensure that budget line items are in compliance with contract line items (and contract items are in compliance with the contract total value), the system is able to confirm and ensure that all requests for payment are created in strict accordance with all levels of the hierarchical contract.

In some forms of the system, billings for the construction project are organized into “Draw periods”. By using such defined periods, project administration is simplified (and expectations are easier to manage) by keeping a consistent payment schedule. Architects, inspectors, and other professionals may be retained to assess work as it is completed and materials as they are provided during each period. Using the defined draw periods makes this inspection/verification process more efficient as the assessment is completed once across the entire project as of a specific “period to” date for each draw period instead of requiring a separate assessment for each payment request.

In order for a payment to be processed, each active Subcontractor on a construction project is expected to submit a Payment Request (e.g., an “Invoice’) for each draw period (step 403). The payment request document is automatically generated by the system based on information provided by the participants. In some forms of the system, the payment request document will list key contract values as well as previously billed amounts. It will also show the full Schedule of Values detail with quantities and percentages of completion for each contract and/or budget line item.

Payment requests typically flow up the project's contractual hierarchy starting with payment requests from the sub-tier contractors to first tier Subcontractors. These payment requests are typically prepared using construction payment management system 201. Then payment requests, which are inclusive of some or all of the value requested by the sub-tier Subcontractors, are prepared by the first tier Subcontractors using construction payment management system 201 and submitted to the General Contractor. Finally, a payment request, which is inclusive of some or all of the value requested by the first-tier Subcontractors, is prepared by the General Contractor typically using construction payment management system 201 and submitted to the Owner for payment.

Payment requests are created using the construction payment management system 201 by entering into the system quantities of delivered or installed items (or percentage of completion) for each of the Schedule of Values detail items. These requested amounts are populated on request for payment documents created by the construction payment management system 201 and are electronically signed by the participant that is requesting payment. The resulting signed request for payment document is then submitted to the contractual parent for review and approval.

As discussed above, in reference to FIG. 5, the construction payment management system, in some forms and arrangements, is configured to ensure that all levels of the contract budget are reconciled before a request for payment can be created. Furthermore, by including full Schedule of Values details along with quantities and percentages of completion as dictated by the data structure illustrated in FIG. 5, the system is incapable of creating invoices that request payment for more (or less) than the agreed upon amount. The construction payment management system also tracks previous payments to ensure that payments for a single budget line item (e.g, an SoV phase code) do not exceed the amount assigned to the budget line item. In this way, the system is configured to provide reliable invoices for values that correspond to agreed upon and hierarchically reconciled budget amounts.

In addition to the payment request document, other documentation might be required prior to receiving a payment in a draw period. For example, the construction payment management system 201 can be configured to require submission of a “sworn statement,” a “conditional lien waiver,” and/or an “unconditional lien waiver.” A sworn statement provides a listing of sub-tier payments made by the Subcontractor. Several states have statutory requirements for such a list to be provided (sometimes referred to as a “contractor affidavit” or a “schedule of third party obligations”). In some forms and arrangements, the construction payment management system is configured to prevent a contractor from creating or submitting a request for payment unless the sworn statement and lien waiver have been received and are stored on the construction payment management system.

All construction actors (including the General Contractor, first-tier Subcontractors, sub-tier Subcontractors, material suppliers, etc.) are eligible for protection under Mechanic's Lien statutes for projects performed in the United States. The laws provide a state-specific framework for Subcontractors to place an encumbrance on the property which was improved by their work or materials if they are not paid for that work/materials. A “lien waiver” document transfers risk by releasing a portion of the Subcontractor's lien right in exchange for payment. In the system described in U.S. Patent Publication No. 2012/0191604, the system is configured to create a lien waiver document and to hold the signed documents until payment is complete. While holding the document (i.e., before the corresponding payment is made), the system prevents all other parties from accessing (e.g., viewing and printing) the signed lien waiver. U.S. Patent Publication No. 2008/0281735 (U.S. application Ser. No. 12/061,805), filed Apr. 3, 2008, the entirety of which is incorporated herein by reference, describes an example of a construction payment management system that provides such lien waiver “vaulting” functionality.

After the payment request is received, the request for payment is submitted to the General Contractor for review and approval (step 405). General Contractors may be working in concert with inspectors, architects, consultants, and engineering firms to assess the work completed and the materials provided by the Subcontractors, material suppliers, and any sub-tier participants. This assessment may include tests for work/materials which are in conformance to the design and requirements defined by the architect's specification. The assessment might also include direct observation of the quantities and progress at a detailed level.

An “Approval for Payment” may also include inquiries of the data regarding the Organization to be paid. For example, the construction project funding system is configured to confirm that the legal name of the entity matches to the name specified for the entity on the subcontract. The construction project funding system is also configured to test forms for financial integrity, completeness, and correctness. Ultimately, the General Contractor (or Owner in the case of the General Contractor's request for payment) will make an approval decision with the aid of the construction project funding systembased on a variety of factors and mark the request for payment as approved in the system.

The system performs a compliance check (step 407) to ensure that all administrative contract requirements are met. These administrative requirements may include, for example, having a signed copy of the subcontract agreement on file, submitting proof of required insurance coverage, submitting weekly “Certified Payroll” details (to allow for audit of prevailing wage rates), and providing lien waiver documents from all subordinate sub-tier contractors. As described in U.S. Patent Publication No. 2012/0191604, the system can be configured to include a contractual compliance engine which constantly monitors the requirements and status data such that “requests for payment” are programmatically placed on hold for non-compliance. Requests for payment may also be evaluated for completeness, accuracy, and estimates of work/materials observed in the field.

In some forms of the system (such as illustrated in FIG. 4), the compliance check is performed after the payment request is approved by the General Contractor. However, in other forms of the system, the compliance check may be performed before or in parallel with the review and approval from the General Contractor. In either case, after the request for payment has been approved by the General Contractor and has cleared the compliance check, the approved request for payment is then forwarded for payment (step 409).

The general process as illustrated in FIG. 4 applies equally whether or not the payment is to be effected using the accelerated payment process or a payment according to the normal payment schedule (e.g., the “pay-when-paid” mechanism). As described in detail below, the General Contractor can decide when (and whether) to offer payment through the accelerated channel based on the particular configuration of the accelerated payment system (for example, the General Contractor can determine whether to offer accelerated payment to a specific contractor, for an entire project, or for specific contracts within a project).

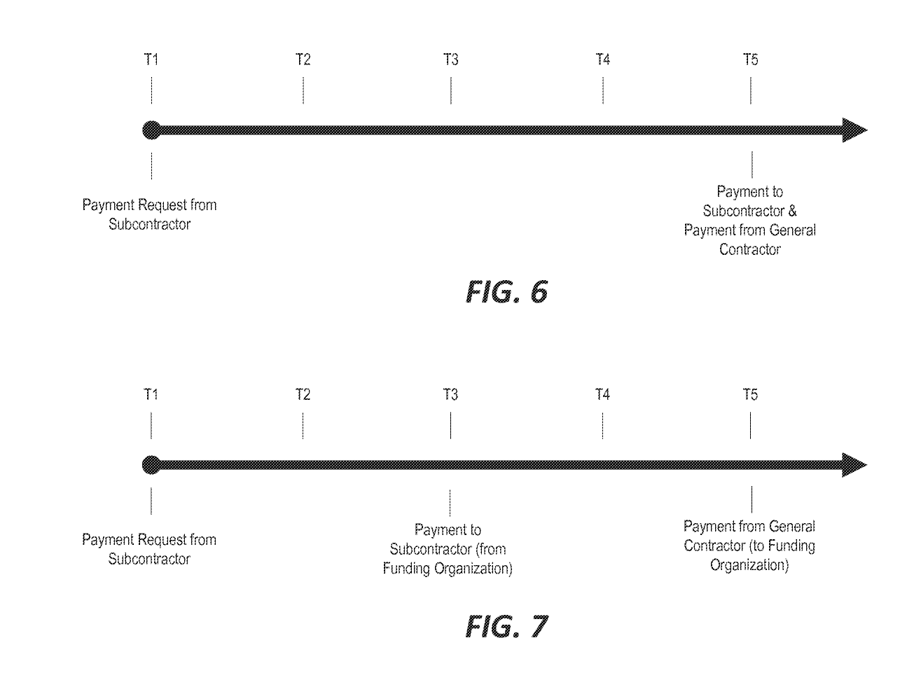

FIG. 6 illustrates an example of the payment process timeline for a “pay-when-paid” transaction using the system. The invoice (i.e., the Request for Payment) is submitted by a Subcontractor at T1. The invoice review/approval process described above (in reference to FIG. 4) proceeds until payment is approved by the General Contractor at T2. A new request for payment is then submitted to the project owner on behalf of the General Contractor at T3. The project owner approves the invoice and makes payment to the General Contractor at T4. After that, payment is made from the General Contractor to the Subcontractor at T5. Again, as noted above, the “pay-when-paid” mechanism is only an example of one way in which payment delay is introduced in a hierarchically organized construction project.

FIG. 7 illustrates a payment timeline using the accelerated payment mechanism utilizing communication with an external Funding Organization. The invoice (i.e., the Request for Payment) is submitted by a Subcontractor at T1 and approved by the General Contractor at T2. At that point, a second Request for Payment is submitted to the project owner at T3 and an instruction is sent to the external Funding Organization to make a payment to the Subcontractor on behalf of the General Contractor. Depending on the specific configuration and the program settings, these events can occur concurrently or they can occur at different stages in the payment timeline. The General Contractor is paid by the Owner at time T4 and the General Contractor makes payment to the Funding Organization at time T5.

As noted above, the construction payment management system is configured to ensure that all hierarchical levels of the construction project budget are reconciled and also tracks previous payments on a budget line item basis. In other arrangements of the system (for example, where a separate construction payment management system is not used), this budget verification and reconciliation process is implemented by the accelerated payment system. Because the requests for payment can only be made when the hierarchical tiers of the budget are reconciled and the participant requesting the payment is verified to be in compliance with the terms of the project contract, the General Contractor can assume with a greater degree of certainty that the request for payment will not be rejected by the Owner when it is passed on to the next hierarchical tier. Because the General Contractor and the Funding Organization have this increased certainty provided by the specialized computing system, the Funding Organization is able to make payment to the Subcontractor and the General Contractor is able to assume an obligation to pay the Funding Organization with a significantly reduced level of risk.

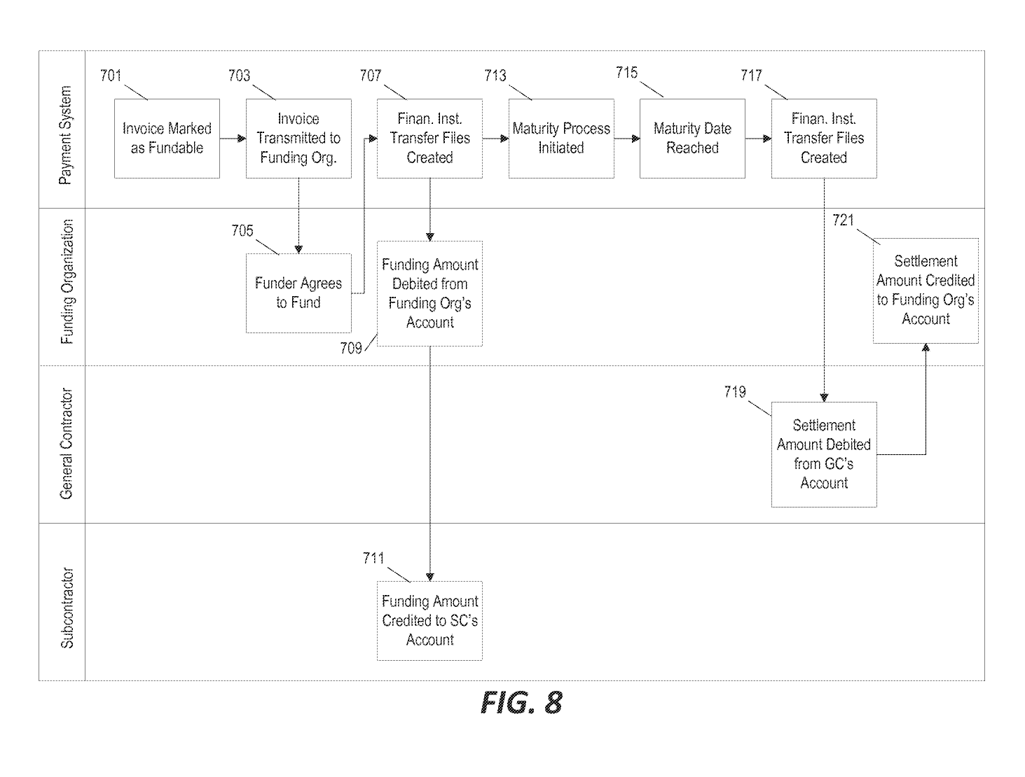

FIG. 8 provides a more detailed view of the accelerated payment process from the perspective of the various involved parties. Once an invoice (i.e., a Request for Payment) is marked as “fundable” by the construction payment management system (step 701), the invoice is transmitted to the Funding Organization (step 703). If the Funding Organization accepts the invoices and agrees to fund the requests for payment (i.e., agrees to assume the obligation to pay the Subcontractor for the invoice) (step 705), then the financial institution transfer files are created (step 707). These files are used to initiate/facilitate a payment between relevant financial institutions (e.g., through ACH). The invoice funding amount is debited from the Funding Organization's bank account (step 709) and credited to the Subcontractor's bank account (step 711).

The process by which the General Contractor pays the Funding Organization is initiated at step 713. Once a “maturity date” is reached (i.e., the date on which the General Contractor is obligated to pay the Funding Organization) (step 715), the relevant financial institution documents are created (step 717). The settlement funds are debited from the General Contractor's bank account (step 719) and credited to the Funding Organization's bank account (step 721).

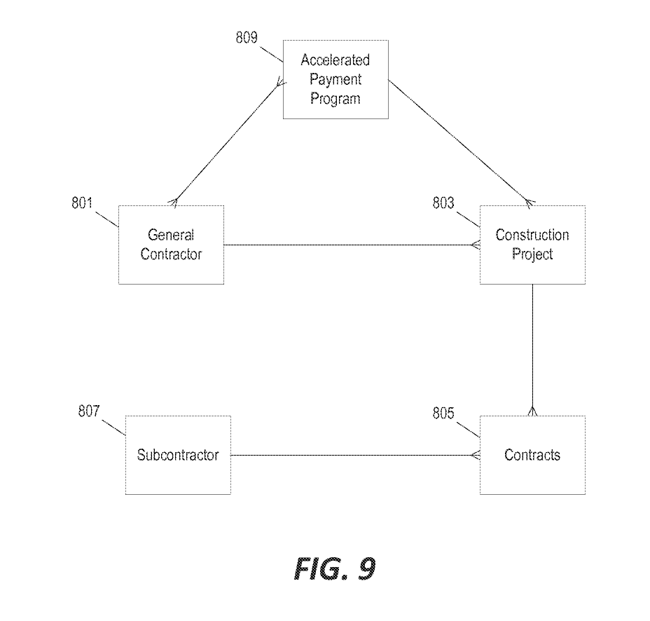

FIG. 9 illustrates the structural arrangement of an accelerated payment program implemented through the accelerated payment system 203 discussed above. As described above, each construction project 803 managed by the system has one General Contractor 801. However, a single General Contractor 801 can manage several concurrent construction projects 803. Furthermore, each project 803 will involve multiple contracts 805. Each contract 805 is directly assigned to one first-tier Subcontractor 807. However, a single first-tier Subcontractor 807 can be associated with multiple contracts 805 for the same project. A General Contractor 801 can establish one or more accelerated payment programs 809 using the system. Some accelerated payment programs may be utilized only by the General Contractor 801 who established the program. However, in some forms of the system, other accelerated payment programs may be utilized by multiple different General Contractors 801. An accelerated payment program may also be utilized for multiple different projects.

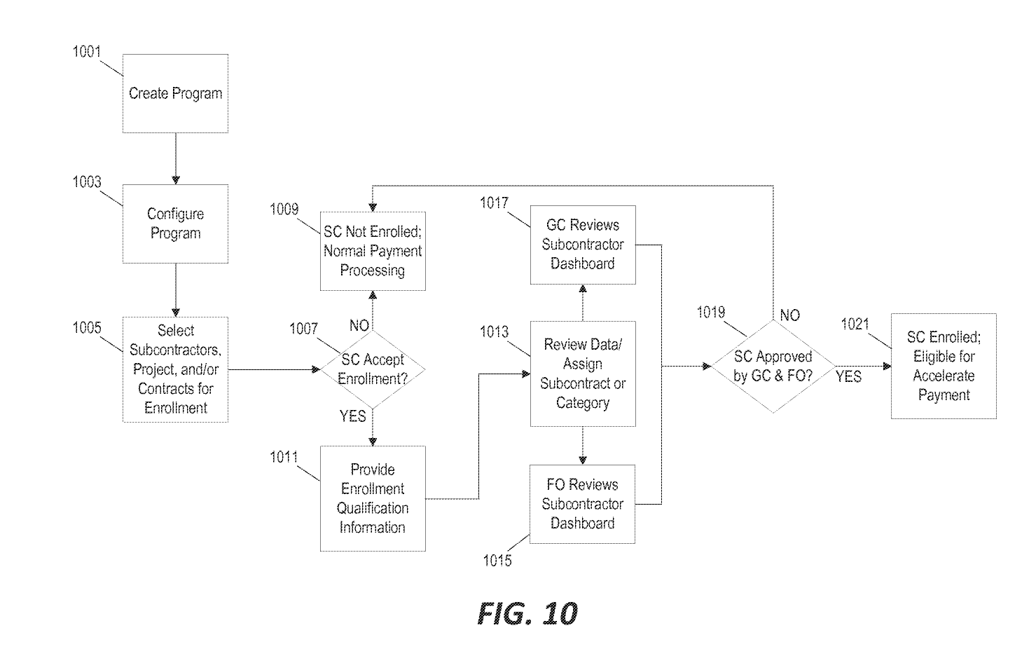

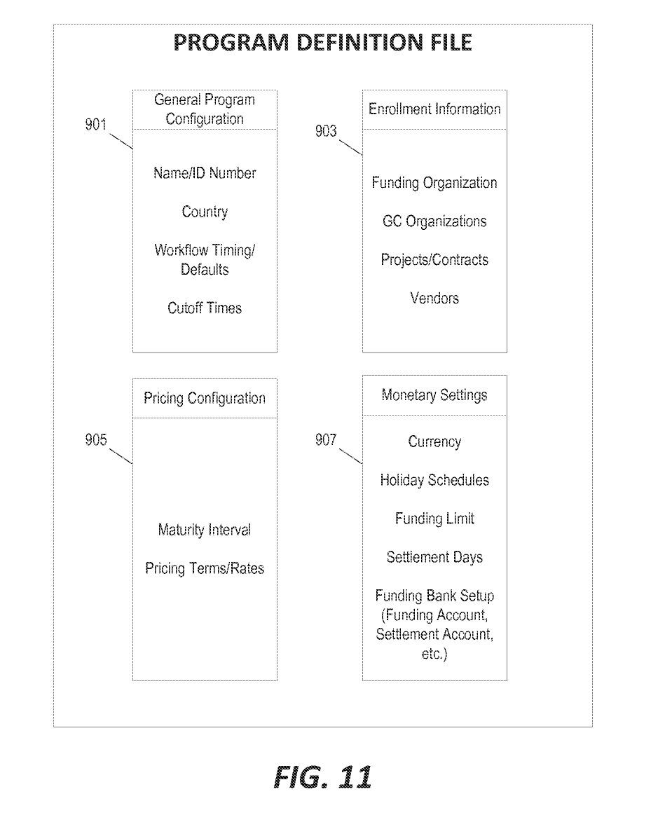

FIG. 10 illustrates the process by which subcontractors are enrolled in an accelerated payment program implemented through the accelerated payment system 203. The General Contractor and the Funding Organization work together to create a new program (step 1001) and to configure the program (step 1003) by providing various parameters that can be defined and adjusted to create the program definition file. An example of the data and parameters that are stored in the program definition file are illustrated in FIG. 11. The general program configuration 901 includes one or more names/ID numbers which are maintained to provide easy cross-reference for reporting and integration between the accelerated payment system and other systems. A country parameter defines the national boundaries of the program for purposes of informing currency and other banking operations. The workflow timing and default settings enable the accelerated payment program to require that certain workflow steps be taken and, in the event of automated integrations, those actions are scheduled to create a cohesive end-to-end workflow for the capture, review, approval, and payment of Payment Requests. Cutoff Times are used by banking entities and other participants to enforce when the transaction must be initiated in order to be processed overnight.

The program also defines enrollment information 903 that identifies the Funding Organization associated with the program (per the terms of the agreement with General Contractor). The enrollment information also identifies General Contractor (i.e., “GC organization”) that is associated with the accelerated payment program. For programs that are utilized by multiple General Contractors, the enrollment information identifies each associated General Contractor. The enrollment information is also configured to selectively define the scope of enrollment in a program. For example, the program can be defined to apply to entire projects, to specific vendors (i.e., Subcontractors and material suppliers), or to one or more specific subcontracts within a project.

The General Contractor is able to define the participants enrolled in the payment program by adjusting the “enrollment information.” The General Contractor may select eligible projects and “enroll all” subcontracts within the project or can select one or more individual subcontracts to enroll. The General Contractor may also select eligible vendors—making subcontracts where those vendors participate in the General Contractor's projects eligible for accelerated funding. As noted above, in some forms and arrangements, the accelerated payment system interacts with a module such as a “qualification module” in which a General Contractor or other party can evaluate specific contractors and determine whether those contractors are eligible for the accelerated payment program.

The program also defines a pricing configuration 905. The pricing configuration defines a maturity interval and pricing terms/rates for the program. The maturity interval dictates the payment terms (i.e., how long from the day that accelerated payment is made to the Subcontractor before the General Contractor must pay the Funding Organization). The maturity interval may be configured to reflect typical payment timing from a project Owner. This configuration allows the General Contractor to offer accelerated payments without changing cash management policies defined by the contract (e.g., “pay-when-paid” terms).

In some forms and arrangements of the system, the Funding Organization pays the Subcontractor at a discounted rate. For example, the Subcontractor can receive 100% of the requested payment (i.e., invoice amount) by waiting for the full contractual payment period to elapse or they can receive 98% of the project cost (or some other percentage of the project cost as agreed between the parties) in the form of an accelerated payment. The enrollment data provided by the Subcontractor and other project/performance data may be used to increment pricing.

A program is further defined in terms of various monetary settings 907 which identify, for example, the currency in which payments will be made, any bank holiday schedules that may affect timing of payments (and maturity), a funding limit, and a settlement period (i.e., the number of days that the bank will require to process payments). The monetary configuration also identifies the financial account information for the Funding Organization (i.e., the account that will be debited for accelerated payments to Subcontractor) and a settlement account (i.e., the account that will be credited for payments from the General Contractor).

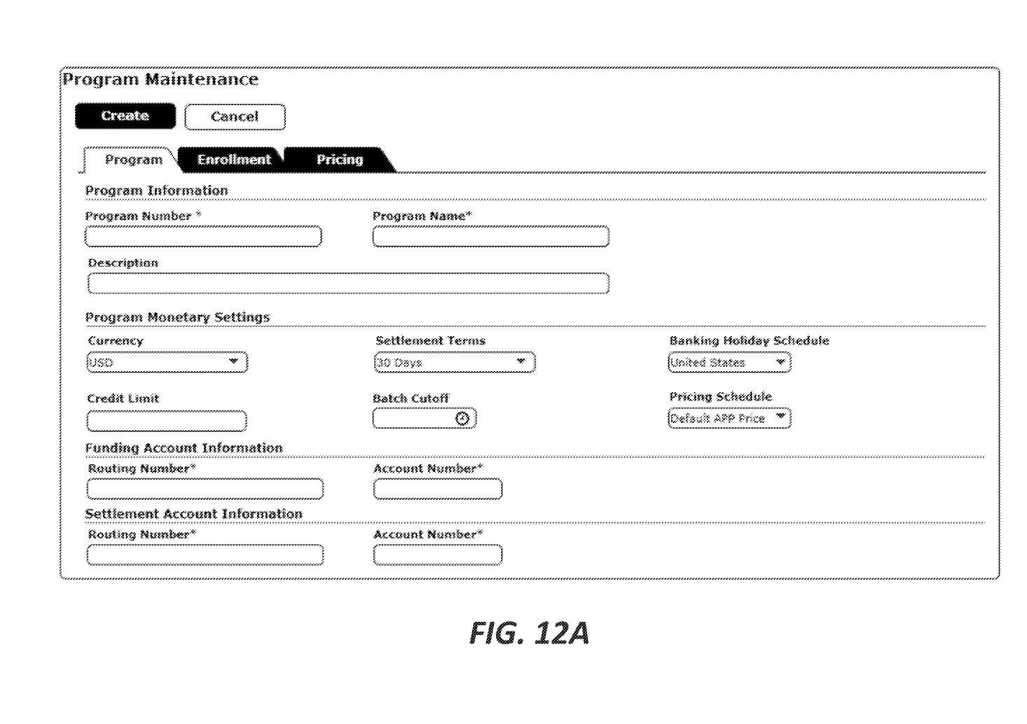

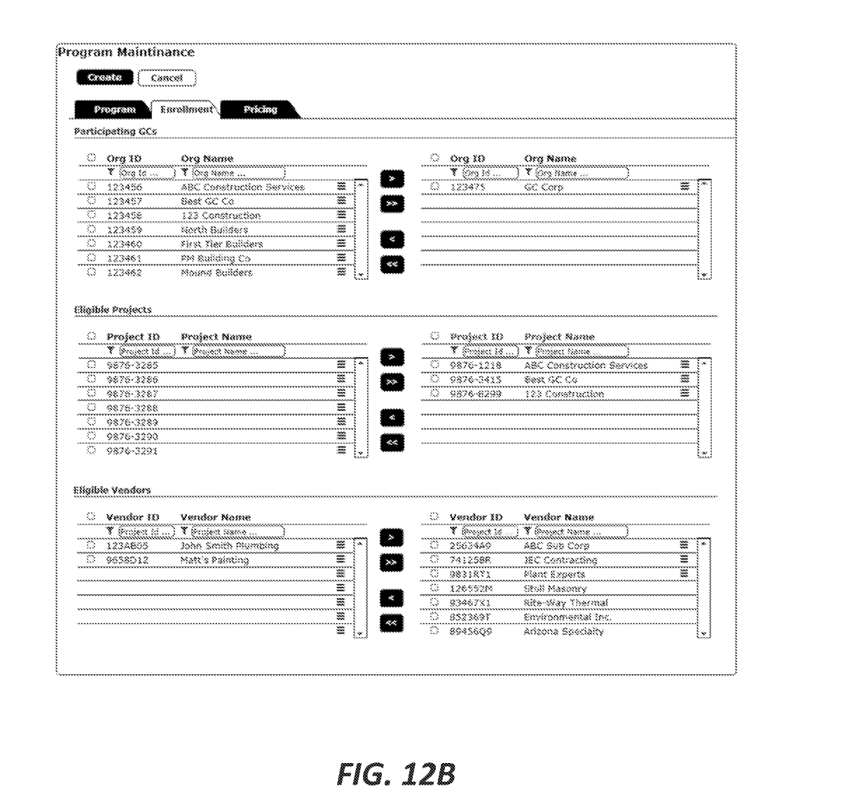

FIGS. 12A and 12B illustrate examples of graphical user interfaces that are displayed to the General Contractor and/or the Funding Organization and are used for receiving the definitional program information discussed in FIG. 11 above. The user interface of FIG. 12A receives general program configuration information. The user interface of FIG. 12B receives program enrollment information. A similar interface is used to receive pricing information for the accelerated payment program.

Returning now to FIG. 10, once the program is created and configured, the General Contractor selects one or more subcontractors, projects, and/or contracts for enrollment in the project (step 1005). If a project is selected for enrollment, then all Subcontractors associated with the project are offered enrollment into the accelerated payment program. Similarly, if a specific contract is selected for enrollment, then all Subcontractors associated with the contract are offered enrollment. Furthermore, if a specific project or a specific contract is selected for enrollment, Subcontractors associated with the specific project or contract will only be able to utilize the accelerated payment system for requests for payment under the specific project or contract. If the Subcontractor submits a request for payment for a non-enrolled contract or for a non-enrolled project, then the request for payment will be processed under the normal payment process.

After the General Contractor selects which Subcontractors, project, and/or contracts are to be eligible for the accelerated payment program, all parties involved must confirm their participation in the program. The system sends a notification to each eligible Subcontractor requesting that they confirm their enrollment in the accelerated payment program (subject to the discount of the program) (step 1007). As discussed further below, such confirmation by the Subcontractor is an important part of the information from the accelerated payment system, which is reviewed and verified by the Funding Organization before making a decision to fund a specific requested payment. Subcontractor identification and other information including confirmation of acceptance of relevant terms of use may be tied to acceptance of enrollment.

If the Subcontractor declines, they are not enrolled and all payment requests will be processed through the normal payment process (step 1009). However, if the Subcontractor accepts, they may be required to provide additional enrollment qualification information (step 1011). In some forms and arrangements of the system, this requested information is provided directly to the accelerated payment system. However, in other forms and arrangements, this information can be provided at any time by the Subcontractor to the prequalification management system such as the one discussed above in reference to FIG. 2. Such a prequalification management system can be implemented solely for storing relevant information and tracking accelerated payment prequalification status for Subcontractor. However, in some embodiments, the prequalification management system stores contractor data that can be later used to qualify (or prequalify) the contractor for a number of different data access and functionality. For example, the data stored on the prequalification management system for a particular contractor can be used to enroll in multiple accelerated payment programs and can also be used to qualify the particular contractor to bid on projects posted by a specific general contractor or project owner.

In some forms and arrangements of the system, the Subcontractor enrollment qualification information is reviewed by a third-party reviewer and assigned to a particular subcontract or category (step 1013). Such a third-party reviewer may provide a score for financial risk and other potential risk classifications for the Subcontractor. However, in other forms and arrangements, the Subcontractor enrollment qualification information may be reviewed by the General Contractor, the Funding Organization, or other participants that have worked with the Subcontractor on other projects. While the use of a third-party reviewer provides an independent evaluation of the Subcontractor's qualifications, the use of General Contractors and Funding Organizations who have worked directly with the Subcontractor on other projects may provide a first-hand evaluation of the Subcontractor that might not otherwise be available to a new General Contractor and Funding Organization considering whether to offer the accelerated payment program to the General Contractor.

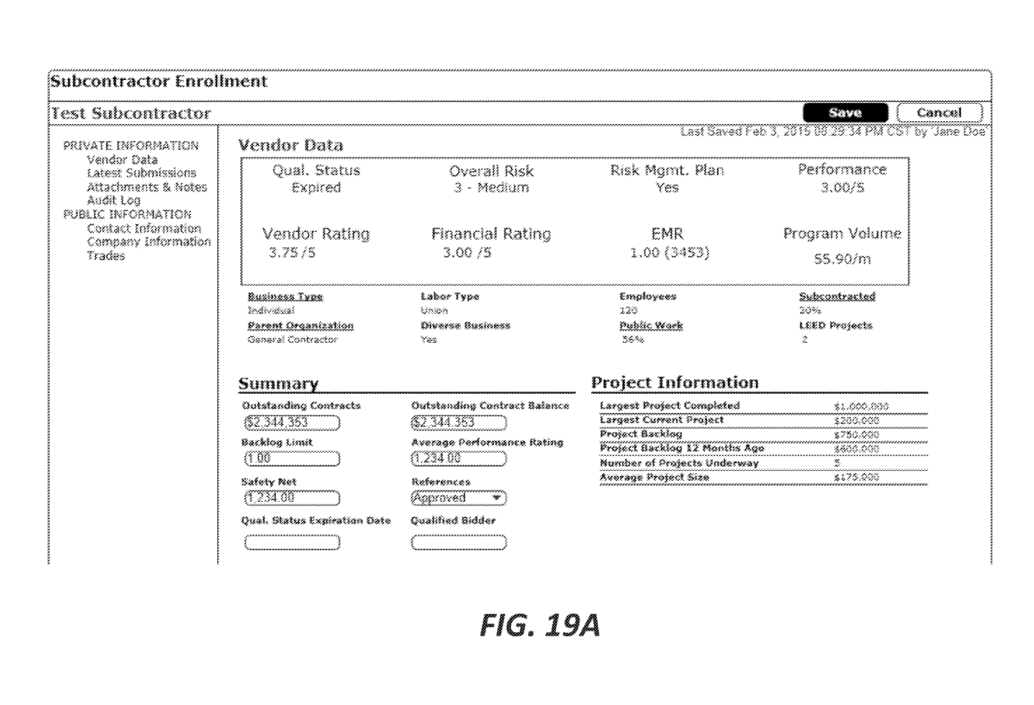

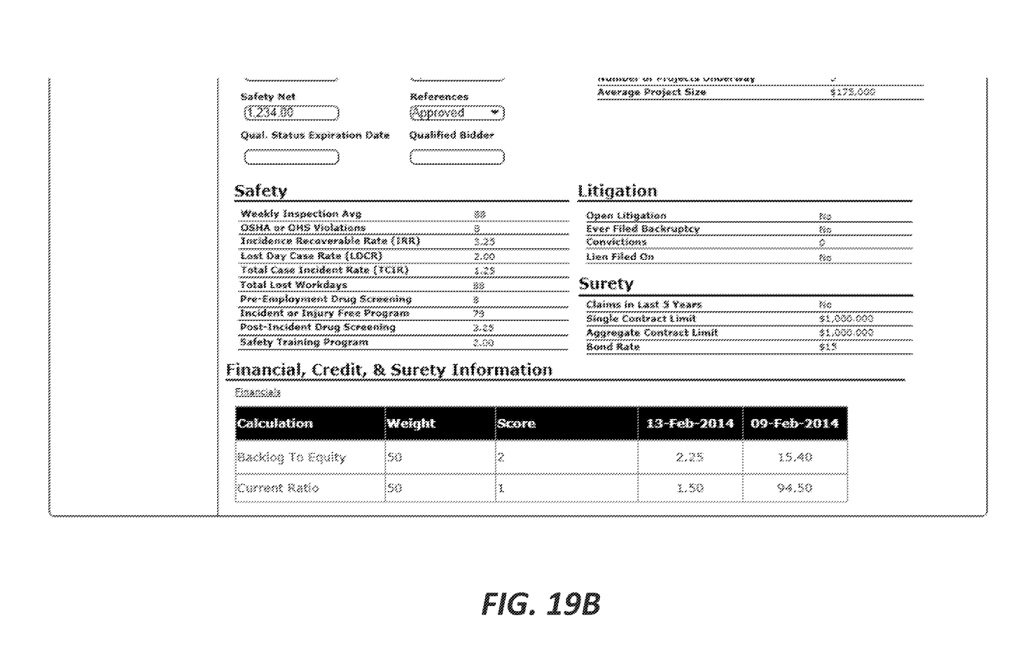

The enrollment qualification data, the scored/evaluation information from the reviewer, and, in some forms and arrangements of the system, additional metrics are displayed to both the General Contractor and the Funding Organization in the form of a Subcontractor Summary Dashboard (steps 1009 and 1011). An example of one such Subcontractor Summary Dashboard is illustrated in FIGS. 19A and 19B, which are discussed in detail below. As discussed in further detail below, the Subcontractor Summary Dashboard in this example is made available to the Funding Organization and the General Contractor at both the enrollment stage and at the accelerated payment approval stage. However, in some forms and arrangements of the system, the Subcontractor Summary Dashboard can be accessed by the General Contractor and the Funding Organization at any time during the course of a project. Alternatively, in still other forms and arrangements of the system, access to the Subcontractor Summary Dashboard might be limited to only one or more specific events (e.g., only at enrollment, only at accelerated payment approval, etc.). Furthermore, in some forms and arrangements of the system, access to the Subcontractor Summary Dashboard might be limited to only a single participant (e.g., either the General Contractor or the Funding Organization) or might be provided to additional participants (e.g., the project owner, other Subcontractors, etc.).

If both the General Contractor and Funding Organization approve the Subcontractor after reviewing the information on the Subcontractor Summary Dashboard (step 1019), then the Subcontractor is enrolled in the accelerated payment program and is eligible to receive payments from the Funding Organization on behalf of the General Contractor (step 1021). The accelerated nature of such payments, however, may be subject to subsequent review and approval on an invoice-by-invoice basis as discussed further below. Furthermore, if either the General Contractor or the Funding Organization rejects the Subcontractor after reviewing the Subcontractor Summary Dashboard, then the Subcontractor is not enrolled in the accelerated payment program and payments will be processed according to the normal payment process.

The method illustrated in FIG. 10 is only one example of how an accelerated payment program might be implemented. In some forms and arrangements of the system, the selection of a Subcontractor by the General Contractor for enrollment at step 1005 is sufficient for approval of the Subcontractor. As such, the General Contractor is not required to later review the Subcontractor Summary Dashboard (step 1017) or provide another later approval (step 1019). Furthermore, in some forms and arrangements of the system (and depending upon the program configuration), the Funding Organization may have no say in whether a Subcontractor is approved for enrollment. Once the Subcontractor is approved by the General Contractor, they are enrolled in the program (possibly subject to review and approval by the Funding Organization on an invoice-by-invoice basis).

As noted above, in some forms and arrangements, the accelerated payment system works in conjunction with the construction payment management system to facilitate payment workflows for many General Contractors, Subcontractors, and other project teams on many different projects. This collaborative functionality enables the parties that are already using a construction payment management system to add the accelerated payment capabilities to their projects through integration between the construction payment management system and the accelerated payment system.

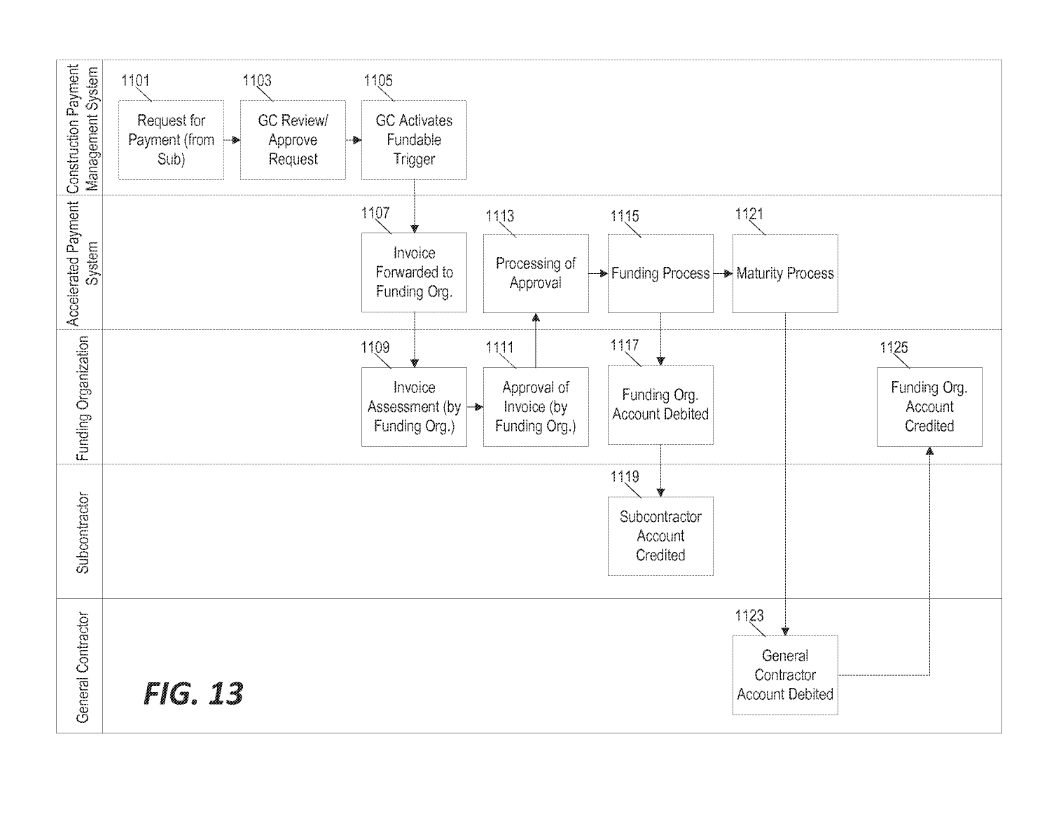

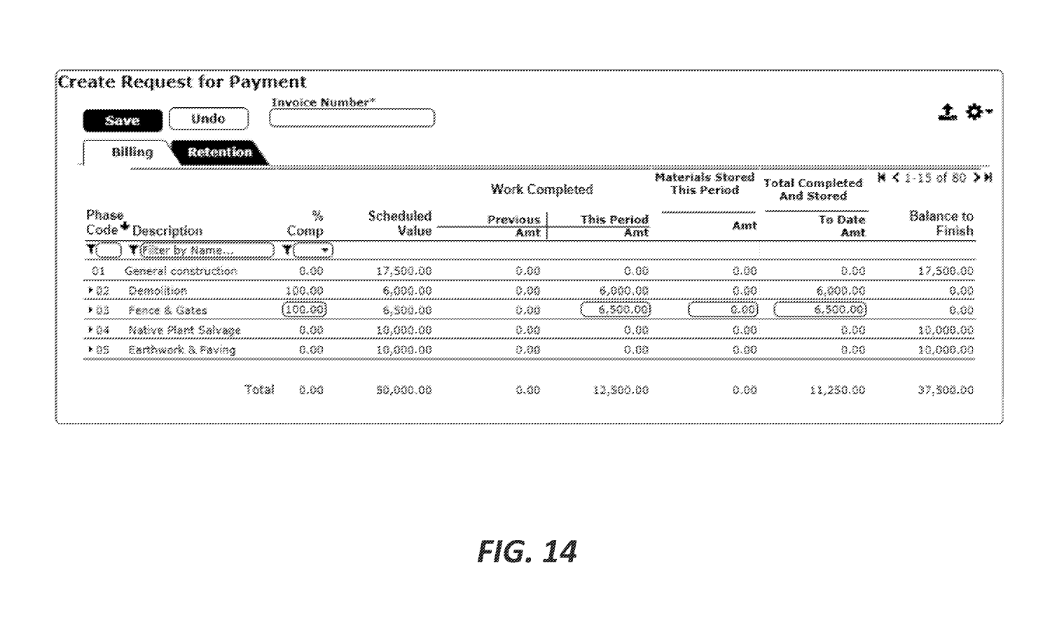

FIG. 13 illustrates the accelerated payment process workflow implemented by the accelerated payment system in conjunction with a construction payment management system. First, a request for payment is submitted by a Subcontractor using the construction payment management system (step 1101). FIG. 14 provides an example of a user interface of the construction payment management system that is used by the Subcontractor to create a request for payment. The Subcontractor may include some or all of their sub-tier Requests for payment in the requested amount. The Subcontractor is then prompted to electronically sign the request and any associated documents (e.g., a lien waiver). As such, the construction project funding system receives, from a first participant associated with the construction project, a request for a payment for services or materials provided in connection with the construction project, the request for payment including a requested payment amount.

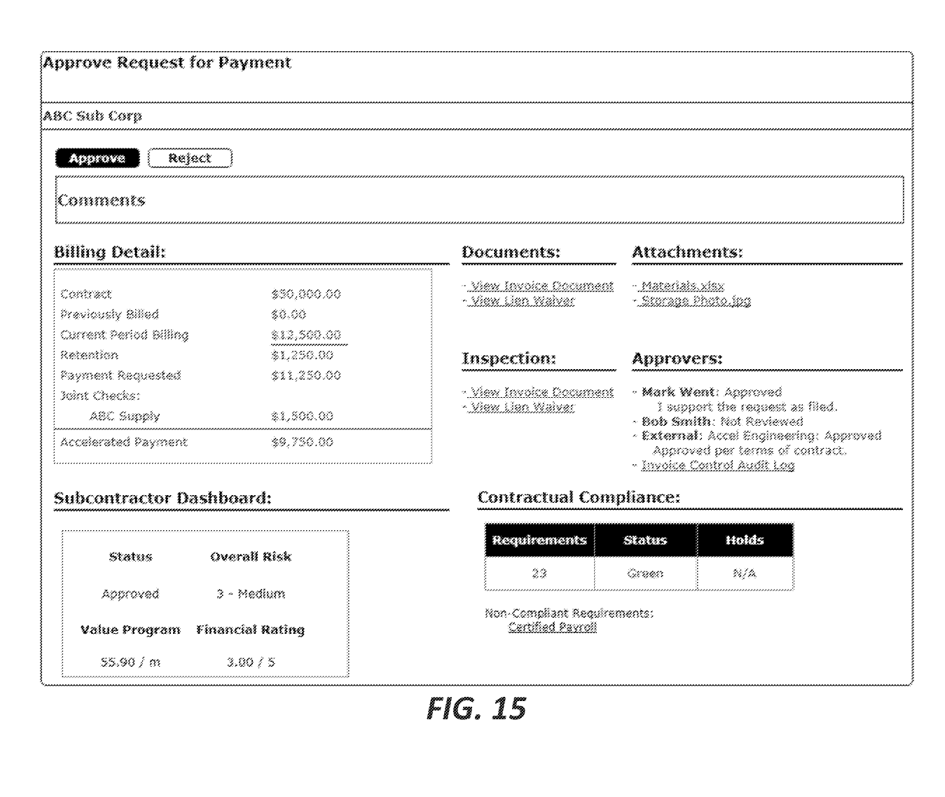

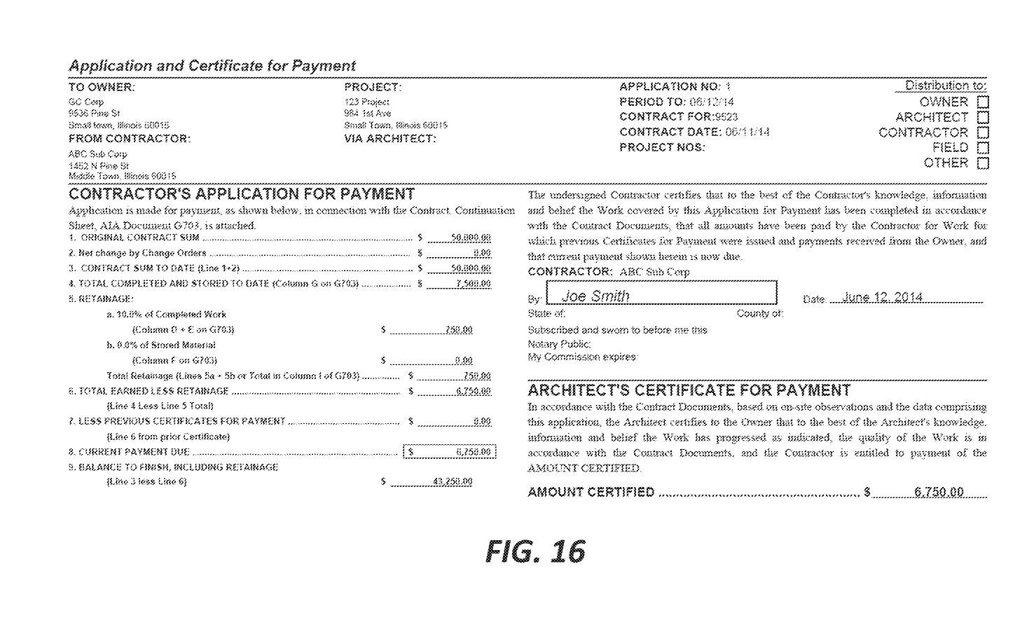

The General Contractor uses the construction payment management system to review and approve the submitted request for payment (step 1103). The General Contractor has access to project source data through the construction payment management system. However, in some forms and arrangements, the accelerated payment system provides an additional “dashboard” summary page that provides information that is used by the General Contractor in deciding whether to approve the request for payment. An example of this summary page is illustrated in FIG. 15. The summary page includes a number of project metrics that either include project source data from the construction payment management system or are calculated based on source data from the construction payment management system. The project metrics shown on the summary page of FIG. 15 include summary information of contract amounts, previously billed amounts, the payment requested for the current draw period, and a summary of the Subcontractor's compliance status. The summary page also provides links to relevant documents. Other implementations may display more, less, or different project metrics. The General Contractor is also able to view the Request for Payment document created and submitted by the Subcontractor. An example of such a Request for Payment document is shown in FIG. 16.

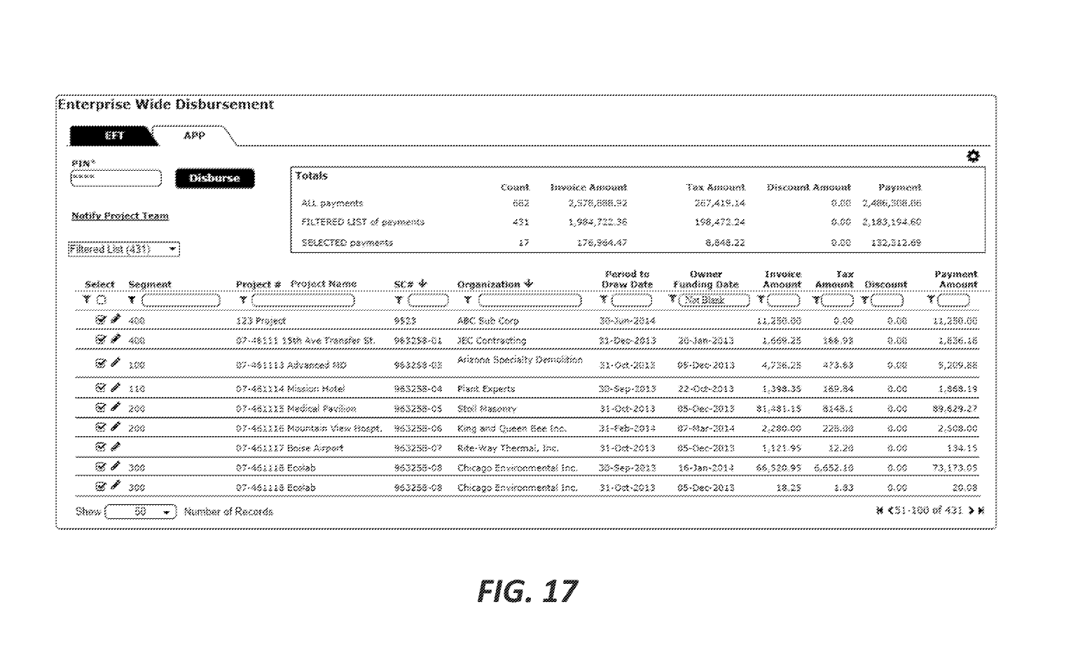

In response to receiving approval of the request for payment from the General Contractor, the construction project funding system releases the Request for Payment to the Funding Organization for payment (step 1105). The release of payment requests for the Funding Organization can be achieved by releasing a single request or a “batch” of payment requests. For example, FIG. 17 illustrates an example of an “enterprise wide disbursement” interface provided to the General Contractor. The screen lists all payment requests that are currently ready for payment (i.e., forwarding to Funding Organization). By selecting the “check” box to the left of a particular invoice and then selecting the “disburse” button, the Fundable Trigger is activated and the selected request for payment is forwarded to the Funding Organization. It is also noted that the example illustrated in FIG. 17 requires the General Contractor to enter a “PIN” to confirm the disbursement before the “disburse” button can be selected. In this way, the construction project funding system receives an approval of the request for payment, the approval being based on a review of a first project metric (i.e., at least one of the metrics displayed on the interface of FIG. 16 or FIG. 17).

In some implementations, the construction project funding system provides no mechanism on the user interface or otherwise by which the General Contractor is able to withdraw or revoke an approval of an accelerated payment after it is granted. As such, the construction project funding system receives an approval of the request for payment from a second participant associated with the construction project, wherein the approval is based on a review of a first project metric by the second participant, and wherein the approval by the second participant cannot be revoked by the second participant and creates an obligation that the second participant satisfy the request for payment by providing payment to the third-party Funding Organization.

In some implementations, the completion of the Fundable Trigger action renders the Payment Requests, which are now subject to review and approval of the Funding Organization, as non-editable for the General Contractor. In this way, the Fundable Trigger is irrevocable by the General Contractor. However, as discussed below, it is still possible that the accelerated payment request may be terminated if not accepted/approved by the Funding Organization.

After the General Contractor reviews and approves the request for payment, the request is forwarded by the accelerated payment system to the Funding Organization for review and approval (step 1107). The Funding Organization can access the request through various mechanisms including directly accessing the accelerated payment system through a web-based interface. Alternatively, the request for payment can be transmitted to the Funding Organization via web services, secure FTP, flat data file, or other mechanisms. As such, the construction project funding system transmits an accelerated payment instruction to the third-party Funding Organization.

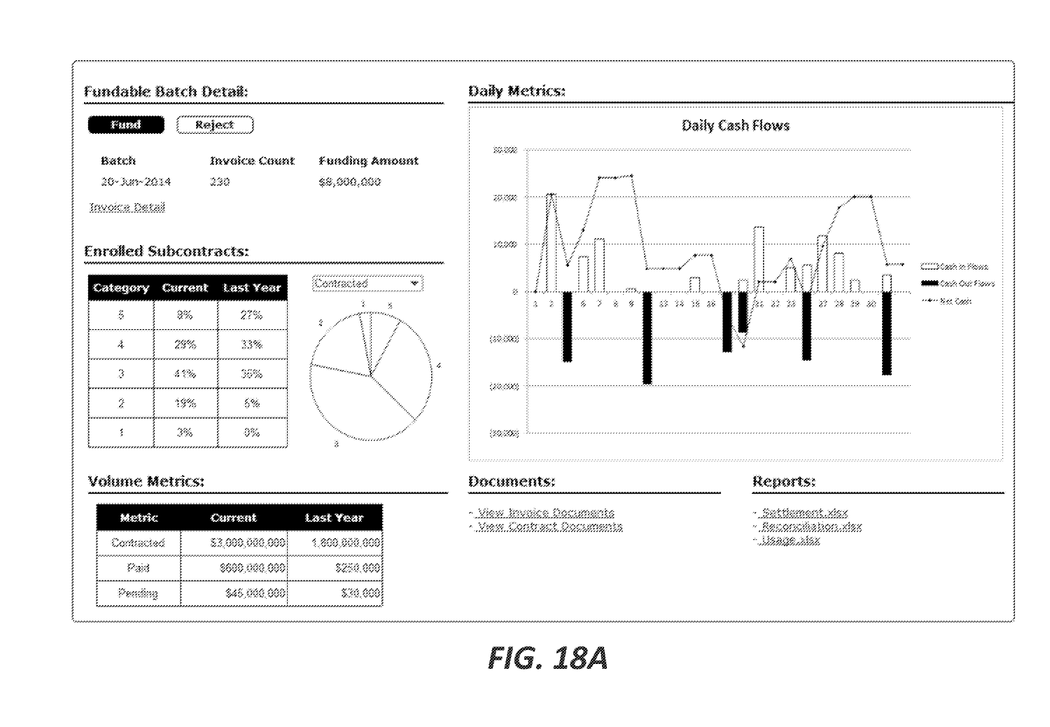

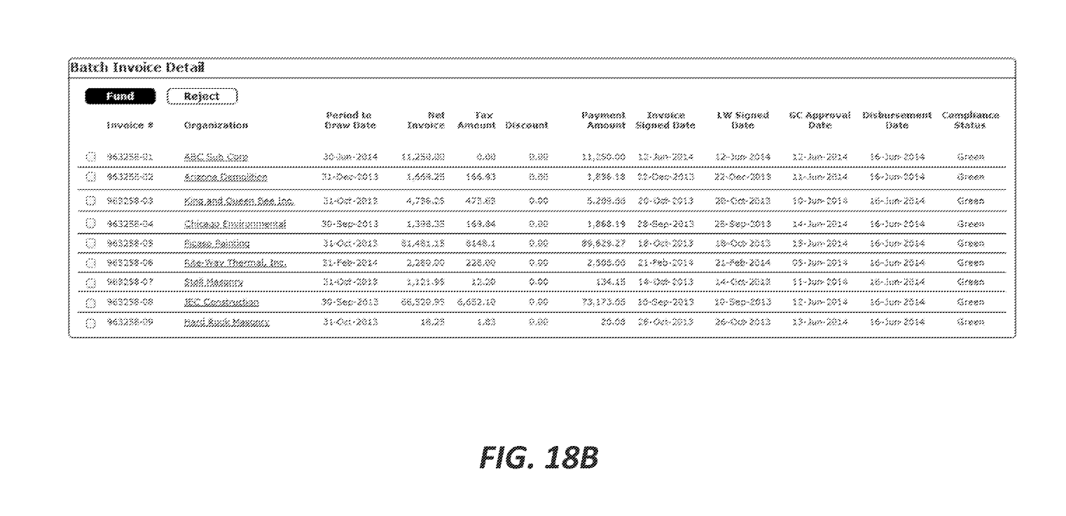

The Funding Organization then reviews the request for payment (e.g., the invoice) (step 1109) in the context of the project data. When accessing the information through the accelerated payment system interface, the Funding Organization is able to view an information summary screen such as the example in FIG. 18A. The summary screen in the example of FIG. 18A provides the Funding Organization with a summary of the total amount of payments requested in a current batch of payment requests and a number of individual requests included in the batch. By clicking the link labeled “Invoice Detail,” the system displays to the Funding Organization a funding summary screen such as illustrated in FIG. 18B. The Invoice Detail screen of FIG. 18B lists each invoice included in the batch that has been forwarded to the Funding Organization for payment along with additional details for each invoice including the associated “draw date,” the total invoiced amount, the tax amount, any discount to be applied to the amount, the total payment amount, the date on which the invoice is signed, the data on which an associated lien waiver was signed, the date on which the General Contractor approved the payment request, the date of disbursement, and an indication of whether the Subcontractor and the payment request are in compliance with the terms of the contract governing the project (and the accelerated payment program).

Returning to FIG. 18A, the summary screen also provides overall summary data to aid the Funding Organization in gauging its ability to accept the batch of payment requests. As described above (and further below in reference to FIGS. 19A and 19B), the accelerated payment system has access to risk data associated with each Subcontractor. Part of this risk data may include an assignment of the Subcontractor to a risk category (i.e., category 1 for relatively low risk Subcontractors and category 5 for relatively high risk Subcontractors). Under the heading “Enrolled Subcontractors,” the summary screen provides an indication of the percentage of the total value of the subcontracts that are enrolled in a given accelerated payment program that fall into each of the defined risk categories. The summary screen also provides in this information in pie chart format and shows how the current risk distribution compares the risk distribution for the previous year. Using the drop-down menu above the pie chart, the Funding Organization can select one of a number of different classifications of information to be displayed on the pie chart and in the data table. In the example of FIG. 18A, the summary screen shows the risk category distribution for the current accelerated payment program. Other selections can include, for example, the risk distribution for invoices that have already been paid this year, all invoices paid to date, invoices included in the current batch, and future invoices that will be payable within the next month.

Similarly, the table under the heading “Volume Metrics” shows the current amount of funds that are currently contracted under the accelerated payment program, the amount already paid by the Funding Organization for previous payment requests, and the amount currently pending payment. These values are again showed as compared to the same metrics from the previous year.

The chart labeled “Daily Cash Flows” provides a summary of the cash requirements to fund the pending payment requests. In particular, the chart on FIG. 18B shows the cash-in or cash-out value for each day as well as a running total of the cash available to or utilized by the accelerated payment program. The net cash metric can help the Funding Organization determine whether they have enough cash invested in the accelerated payment program to fund the current batch of payment requests.

The summary screen also provides access to documentation such as the original invoice documents and the original contract documents that are enrolled in the accelerated payment program. Links are also provided to summary reports that provide information relevant to settlement, reconciliation, and usage, for example.

The summary screen also includes a “fund” button and a “reject” button. These buttons can be used by the Funding Organization to fund or reject the batch of invoices as a whole. Alternatively, the Funding Organization can review payment requests on an invoice-by-invoice basis by selecting the “Invoice Detail” link. Then, on the user interface of FIG. 18B, the Funding Organization can use the check boxes to the left of each listed invoice to indicate whether the invoice will be funded or rejected. Furthermore, when viewing the Invoice Detail screen, the Funding Organization can select an individual invoice which will cause the system to display additional information relevant to the particular invoice (for example, a screen similar to the one illustrated in FIG. 15).

In some implementations, the Funding Organization is also granted access to certain project data that enables assessment of the quality of the Payment Request which is to be funded. These project metrics may include, for example, an indication of whether the Subcontractor has accepted enrollment in the accelerated payment program for this specific subcontract, information about the project team (including identification of involved participants, information about the normal payment process in place on the project, historical payment data about the project, and information about the processes and performance of the team), and information about lien rights in place across the project (including details about which lien waivers have been received).

In some implementations of the system, the Funding Organization may be granted access to project source data directly from the construction payment management system. This access provides the Funding Organization with a source of consistent high-quality payment requests (e.g., invoices) which have not previously been available for construction projects. As noted above, the quality and reliability of the requests for payment (as provided by the construction payment management system) make it possible for the General Contractor and the Funding Organizations to accept the obligations imposed by utilizing the accelerated payment system with increased certainly and reliability. The construction payment management system ensures that the payment requests are created as per contractual data included within the construction payment management system and the business rules enforced on the project. General Contractors, inspectors, architects, consultants, and other engineering firms may assess requests for conformance to the design and specification as well as direct observation of the quantities and progress at a detailed level. The construction payment management system also stores forms (e.g., invoice and other documents) that are produced with financial integrity, completeness of form data, and using the correct templates required by the project.

As also discussed above, the integration of the accelerated payment system with a construction payment management system and a prequalification management system supports enrollment of qualified Subcontractors by collecting organizational data such as, for example, legal entity/tax ID, insurance (liability, automobile, and workers' compensation), banking information, bonding details, financial information/statements, affiliations, association, awards, business classification information, employee information, geographic areas, LEED (environmental) certification, licenses, litigation information, project performance information, references, Subcontractor/specialty trades, union agreements, and quality/safety information. Third-party review of the information provided above can also be used to score the financial or other risk represented by the collected organizational data. In various implementations of the system (and depending upon the program definition settings established by the participants), these and other metrics may be made available to the Funding Organization to assist them in their decision.

FIGS. 19A and 19B provide an example of a user interface including several project metrics that is displayed to the Funding Organization to aid their review prior to accepting an accelerated payment request. Like the summary page shown to the General Contractor in FIG. 15, the project metrics shown on this user interface can include project source data from the construction payment management system or project metrics that are calculated based on source data from the construction payment management system. Furthermore, as shown in FIGS. 19A and 19B, the project metrics can include information provided by a Subcontractor (or about a Subcontractor) through the prequalification management system.

As shown, in FIG. 19A, the Subcontractor Enrollment Dashboard screen displays a summary of “Vendor Data” including information such as the vendor's qualified status (i.e., whether the vendor is enrolled in the program), risk scores assigned to the vendor (either automatically by the system or manually by a reviewer), and an indication of whether a “risk management plan” is in place for the vendor. The page also shows a summary of the vendor's financial status including the total value of outstanding contracts.

As illustrated on FIG. 19B, the Subcontractor Enrollment Dashboard also shows a summary of vendor safety information including a score, a “lost day case rate,” a “recordable incident rate,” and other information relating to worker injury and safety. The Dashboard also provides a summary of any relevant litigation information (i.e., any open cases, every filed bankruptcy, ever filed a lien, ever failed to complete a project) and a summary of the vendor's financial, credit, and surety information.

As such, the accelerated payment system makes available a second project metric (i.e., any of the metrics discussed above in reference to FIGS. 18A, 18B, 19A, and 19B) to the third-party Funding Organization.

Returning now to the method of FIG. 13, the Funding Organization indicates acceptance of the request for payment and approval of the accelerated payment (step 1111) after reviewing the available information discussed above. After the construction project funding system receives the funding approval from the third-party Funding Organization confirming that the accelerated payment for a requested payment amount will be funded by the third-party Funding Organization, that approval is communicated to the accelerated payment system (step 1113), which then initiates the funding process (step 1115). This communication establishes the date on which the Funding Organization has agreed to fund the Payment Requests. At this point, all of the contractual obligations of the accelerated payment program are attached to the invoice. If the Funding Organization reviews the payment request within the interface environment of the accelerated payment system, then the communication of the approval is internal to the system. However, if the Funding Organization is using an external computer system to review the request, then the approval is communicated using a similar communication protocol to that of step 1107 between the two systems.

The accelerated payment system then facilitates that payment from the Funding Organization to the Subcontractor using the financial information provided by the Subcontractor and the financial information defined for the accelerated payment program. The invoice amount (at the contractually agreed upon discounted rate) is debited from the Funding Organization's account (step 1117) and credited to the Subcontractor's account (step 1119). This transaction can be facilitated using, for example, ACH, EFT, wire transfer, or other fund disbursal mechanisms. At the end of the contractually agreed upon maturity period (step 1121), the General Contractor's account is debited for the amount due for payment of the accelerated payment (step 1123) and the Funding Organization's account is reimbursed (step 1125).

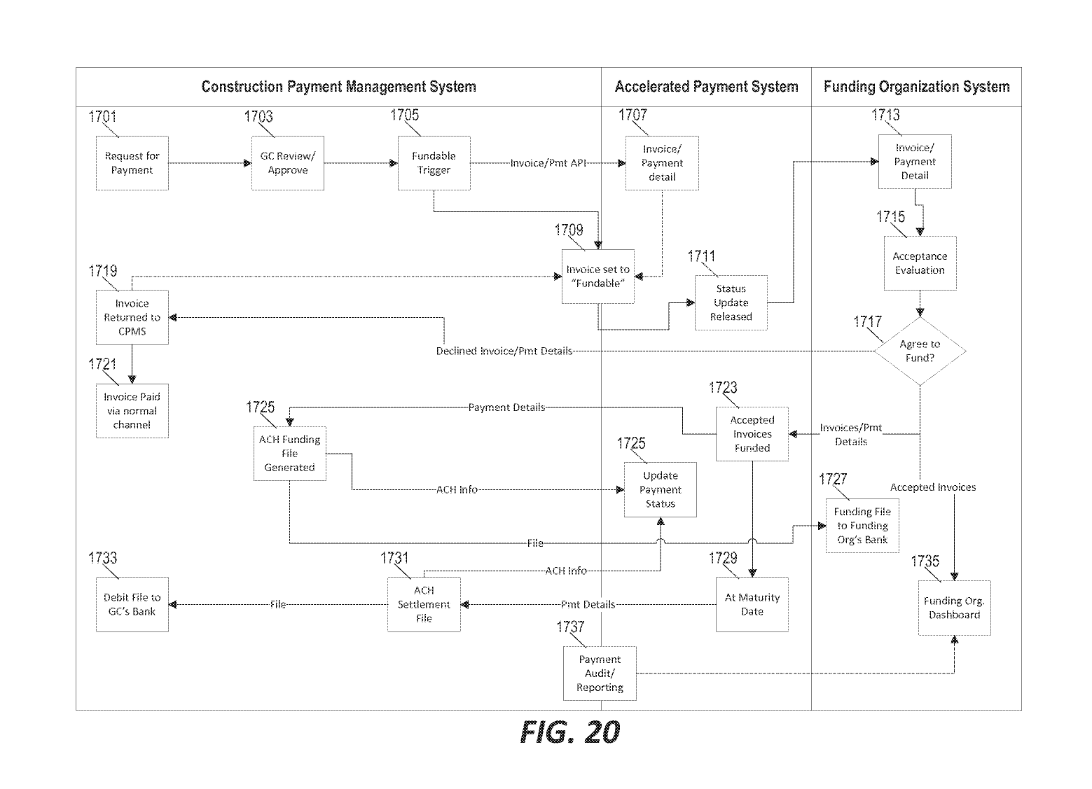

FIG. 20 provides a more detailed illustration of a method for effecting accelerated payment using the accelerated payment system described above. The Subcontractor submits a request for payment (step 1701) and the request is reviewed/approved by the General Contractor (step 1703). The General Contractor activates a “Fundable Trigger” (e.g., selecting the payment request for forwarding and confirming that the invoice is to be forwarded) (step 1705) and the invoice enters the accelerated payment system workflow (step 1707). The status of the invoice is also updated to “fundable” to reflect the activation of the Fundable Trigger (step 1709). A status update is released by the accelerated payment system (step 1711) and the details of the invoice are received by the Funding Organization's system (step 1713).

After reviewing the request for payment and any relevant information (step 1715), the Funding Organization decides whether to accept or reject the request (step 1717). If the invoice is rejected by the funding company (e.g., the accelerated payment funding limit is exceeded, Subcontractor is not in compliance, etc.), then the invoice is returned to the construction payment management system for normal processing (step 1719). Payment is then made to the Subcontractor through the normal payment method.

However, if the invoice is accepted, the accelerated payment system is notified (step 1723) and an ACH funding file is generated by the construction payment management system (step 1725). The file is transmitted to the Funding Organization's bank (step 1727) and the accelerated payment is made to the Subcontractor. The status of the invoice is also updated within the accelerated payment system (step 1725). At the maturity date (step 1729), another ACH settlement file is generated (step 1731) and a debit file is transmitted to the General Contractor's bank (step 1733) to facilitate payment to the Funding Organization.

The system is also configured to provide the Funding Organization with an updated “dashboard” interface (step 1735) that displays, for example, all accepted accelerated payment requests, pending request, and completed payments. The accelerated payment system also provides various auditing and reporting information regarding the status of any pending or completed payments (step 1737). These reports can include an Accepted Invoices report, a Fundable Invoices report, a Declined Funding Details report, a Funding Reconciliation report, a Settlement Aging report, Settlement Reconciliation report, and an Existing Invoices report.

The “Accepted Invoices” report provides a listing of invoices and their associated details which were accepted by the Funding Organization and will be part of a “buy offer” (i.e., a document by which the Funding Organization agrees to fund one or more invoices to Subcontractors). The “Fundable Invoices” report lists invoices and their associated details which were provided to the Funding Organization, but have not yet been accepted by the Funding Organization. The “Declined Funding Details” report provides a listing of invoices and their associated details which were not accepted by the Funding Organization and will not be part of a “buy offer.” The “Funding Reconciliation” report provides details to both the Funding Organization and the General Contractor (and, in some cases, the Subcontractors) about invoices/amounts funded. The “Settlement Aging” report provides an aging view of invoices which were previously funded but are still pending their maturity date. The “Settlement Reconciliation” report provides detail to both the Funding Organization and the General Contractor regarding the invoices and amounts which will settle to their respective accounts as a result of a maturity payment. The “Existing Invoices” report shows the Funding Organization the values of all invoices (or requests for payment) that exist in the system, but have not yet been submitted to the Funding Organization for funding. This report provides a forward looking view on how soon the General Contractor might approach their funding limit for the accelerated payment program.

The methods and systems described above are only some examples of an accelerated payment system. They can be modified and adapted in other implementations of the system. For example, the system can be implemented to allow a “one-time” approval by the Funding Organization which covers all payments against a specific project (or a specific contract). The Funding Organization reviews and approves the enrollment and contractor data and provides an approval that constitutes an acceptance of all future Payment Requests for the subcontract/project. As payment requests are released by the General Contractor to the Funding Organization, they are simply funded under the terms of the previous approval. This is in contrast to implementations of the system where an invoice-by-invoice approval is required from the Funding Organization, in which the Funding Organization is required to review and approve each individual invoice before it is paid.

In some implementations of the system, the General Contractor is able to select between accelerated payment and normal payment disbursement on an invoice-by-invoice basis. In such systems, the General Contractor selects a payment channel upon approving each individual payment request. Similarly, the system may be implemented to require the Subcontractor to indicate acceptance of the accelerated payment process each time they submit a new request for payment. In some such implementations, the Subcontractor is pre-configured as eligible for accelerated payment, but has the option to select whether accelerated payment is requested.

Furthermore, in some forms and arrangements, the accelerated payment system can be configured to require the Subcontractor to “re-accept” enrollment in the accelerated payment program prior to submitting an invoice. The system can be configured to require such a “re-acceptance” periodically (e.g., once a year), each time the pricing arrangement changes, or on an invoice-by-invoice basis.

In some forms and arrangements of the system, the Subcontractor can define the day on which they are to be paid. In such cases, the arrival of the scheduled day (after approval of the invoice by the General Contractor) is the “Fundable Trigger” that causes the invoice to be forwarded to the Funding Organization.

In some forms and arrangements, the system can be configured to programmatically decide when to “opt out” of the accelerated payment program. For example, if the daily value of payment requests (or the cumulative outstanding value) exceeds a program funding limit, the system may automatically defer one or more invoices from the accelerated funding channel and return them to the normal payment channel. Similarly, if the program were configured with a Cutoff Date on the payment terms (e.g., accelerated payment is only valid for 7 days after month ends), any invoices received after the cutoff date would be removed from the accelerated payment channel and paid according to the normal process.

Furthermore, in some implementations, the accelerated payment system can be configured such that the Funding Organization receives and holds one or more documents relating to the construction payment process. For example, when a Subcontractor submits a request for payment and a lien waiver, the lien waiver document can be held by the accelerated payment system or forwarded to the Funding Organization. The lien waiver document is then released to the General Contractor only after the Funding Organization is reimbursed for the accelerated payment made to the Subcontractor.

As noted above, the accelerated payment system can be integrated with various other construction payment management systems. Some such systems include compliance check mechanisms in which payments to a Subcontractor are put on hold until the associated Subcontract is in compliance. In some forms and arrangements, the accelerated payment system can be configured such that compliance holds extend to invoices which have been approved for payment by the Funding Organization. In this way, the accelerated payment system can suspend the accelerated payment process even after the accelerated payment has been approved by the General Contractor and the request for payment has been forwarded to the Funding Organization.

Although the examples discussed above focus on payments made to a Subcontractor on behalf of the General Contractor, the systems may also be configured to extend accelerated payments from a project owner to a General Contractor. Similarly, the accelerated payment system described above can be configured to provide accelerated payments from a Subcontractor to a sub-tier participant (i.e., sub-tier contractor or materials suppliers).

Thus, the invention provides, among other things, a system for arranging and managing financial transactions and data access between parties in a hierarchically organized construction project to facilitate payments on an accelerated basis. Various features and advantages of the invention are set forth in the following claims.

What is claimed is:

1. A construction project funding system comprising a networked computer server for processing accelerated payments, associated with a construction project, that are funded through a third-party funding source, the server configured to:
receive, from a first participant associated with the construction project, a request for a payment for services or materials provided in connection with the construction project, the request for payment including a requested payment amount;
receive an approval of the request for payment based on a review of a first project metric;
transmit an accelerated payment instruction to the third-party funding source;
make available a second project metric to the third-party funding source; and
receive a funding approval from the third-party funding source confirming that an accelerated payment for the requested payment amount will be funded by the third-party funding source.

2. The construction project funding system of claim 1, wherein the server is configured such that the approval of the request for payment is performed by a second participant.

3. The construction project funding system of claim 2, wherein the first participant is a sub-contractor or materials supplier for the construction project, and wherein the second participant is the general contractor on the construction project.

4. The construction project funding system of claim 2, wherein the first project metric is automatically generated by the construction payment management system.

5. The construction project funding system of claim 4, wherein the first project metric includes whether the first participant is in contractual compliance with respect to the project.

6. The construction project funding system of claim 4, wherein the first project metric includes whether the first participant is the correct entity to receive payment in response to the request for payment.

7. The construction project funding system of claim 4, wherein the first project metric includes confirmation of whether the materials or services for which payment is being requested have been delivered or completed.

8. The construction project funding system of claim 1, wherein the server is configured such that the approval of the request for payment is performed automatically by the server.

9. The construction project funding system of claim 8, wherein the first project metric includes whether the first participant is in contractual compliance with respect to the project.

10. The construction project funding system of claim 8, wherein the first project metric includes whether the first participant is the correct entity to receive payment in response to the request for payment.

11. The construction project funding system of claim 8, wherein the first project metric includes confirmation of whether the materials or services for which payment is being requested has been delivered or completed.

12. The construction project funding system of claim 1, wherein the server is configured to transmit the first project metric to a party providing approval.

13. The construction project funding system of claim 1, wherein the server is configured to process both accelerated payments and ordinary payments made in the ordinary course of a construction project.

14. The construction project funding system of claim 13, wherein the server is configured to allow a second participant to select to process a request for payment either as an accelerated payment or as an ordinary payment.

15. The construction project funding system of claim 13, wherein the server is configured to automatically select whether to process a request for payment as an accelerated payment or as an ordinary payment based on evaluation of project metrics or first participant data.

16. The construction project funding system of claim 13, wherein the server is configured to allow a selection to process a request for payment as either an accelerated payment or an ordinary payment to be performed in response to each request for payment.

17. The construction project funding system of claim 13, wherein the server is configured to allow a selection to process a request for payment as either an accelerated payment or an ordinary payment to be done for an entire project or contract.

18. The construction project funding system of claim 1, wherein the third-party funding source includes a financial institution, and wherein the approval received from the third-party funding source indicates that a payment obligation has been assumed by a second participant associated with the construction project and that the accelerated payment to the first participant will be repaid to the third-party funding source by the second participant.

19. The construction project funding system of claim 1, wherein the approval received from the third-party funding source establishes an obligation on a second participant associated with the construction project to pay the third-party funding source.

20. The construction project funding system of claim 1, wherein the first project metric and the second project metric are identical.

21. The construction project funding system of claim 1, wherein the approval is performed by a second participant associated with the construction project, and wherein the approval of the request for payment automatically establishes an irrevocable status for the approval of the request for payment that cannot be withdrawn by the second participant.

22. The construction project funding system of claim 1, wherein the server is configured to allow the funding approval from the third-party funding source to be performed for an entire contract.

23. The construction project funding system of claim 1, wherein the server is configured to allow the funding approval from the third-party funding source to be performed for an entire project.

24. The construction project funding system of claim 1, wherein the server is configured to allow the funding approval from the third-party funding source to be performed for each accelerated payment instruction.

25. The construction project funding system of claim 1 wherein the first participant may select the timing of the payment.

26. The construction project funding system of claim 25, wherein the timing of the payment affects the amount of the payment.

27. The construction project funding system of claim 1, wherein the request for payment is a request for an accelerated payment for work performed by the first participant for a second participant and wherein the approval of the request for payment is received from the second participant.

28. The construction project funding system of claim 1, wherein the server is further configured to
store a project budget including a contract amount, a plurality of contract line items, and a plurality of budget line items, each contract line item including a value and each budget line item includes a value, wherein each budget line item is assigned to one contract line item;
determine whether the project budget is hierarchically reconciled, wherein the project budget is hierarchically reconciled when a sum of the values for each contract line item equals the contract amount and a sum of the values of each budget line item assigned to a first contract line item of the plurality of contract line items equals the value of the first contract line item;
allow the first participant to submit the request for payment only when the project budget is hierarchically reconciled.

29. The construction project funding system of claim 28, wherein the server is further configured to automatically generate the request for payment such that the requested payment amount is based only on one or more budget line items included in the project budget and verified as at least partially completed.

30. A construction project funding system comprising a networked computer server for processing accelerated payments associated with a construction project that are funded through a third-party funding source, the server configured to:
receive, from a first participant associated with the construction project, a request for a payment for services or materials provided in connection with the construction project, the request for payment including a requested payment amount; and
receive an approval of the request for payment from a second participant associated with the construction project, wherein the approval is based on a review of a first project metric by the second participant, and wherein the approval by the second participant cannot be revoked by the second participant and creates an obligation that the second participant satisfy the request for payment by providing payment to the third-party funding source.

31. The construction project funding system of claim 30, wherein the first project metric is automatically generated by the construction payment management system.

32. The construction project funding system of claim 30, wherein the first project metric includes whether the first participant is in contractual compliance with respect to the project.

33. The construction project funding system of claim 30, wherein the first project metric includes whether the first participant is the correct entity to receive payment in response to the request for payment.

34. The construction project funding system of claim 30, wherein the first project metric includes confirmation of whether the materials or services for which payment is being requested have been delivered or completed.

35. The construction project funding system of claim 30, wherein the server is configured to transmit the first project metric to the party conducting approval.

36. The construction project funding system of claim 30, wherein the server is configured to process both accelerated payments and ordinary payments made in the ordinary course of a construction project.

37. The construction project funding system of claim 36, wherein the server is configured to allow the second participant to select to process a request for payment either as an accelerated payment or as an ordinary payment.

38. The construction project funding system of claim 36, wherein the server is configured to automatically select whether to process a request for payment as an accelerated payment or as an ordinary payment based on evaluation of project metrics or first participant data.

39. The construction project funding system of claim 36, wherein the server is configured to allow a selection to process a request for payment as either an accelerated payment or an ordinary payment to be performed in response to each request for payment.

40. The construction project funding system of claim 36, wherein the server is configured to allow a selection to process a request for payment as either an accelerated payment or an ordinary payment to be done for an entire project or contract.

41. The construction project funding system of claim 30, wherein the server is further configured to transmit an accelerated payment instruction to the third-party funding source and receive a funding approval from the third-party funding source confirming, based on a review of a second project metric, that an accelerated payment for the requested payment amount will be funded by the third-party funding source.

42. The construction project funding system of claim 41, wherein the funding approval received from the third-party funding source establishes an obligation on a second participant associated with the construction project to pay the third-party funding source.

43. The construction project funding system of claim 41, wherein the first project metric and the second project metric are identical.

44. The construction project funding system of claim 30, wherein the first participant is a sub-contractor or materials supplier for the construction project, and wherein the second participant is the general contractor on the construction project.

45. The construction project funding system of claim 30, wherein the approval of the request for payment is performed by a second participant associated with the construction project, and wherein the approval of the request for payment automatically establishes an irrevocable status for the approval of the request for payment that cannot be withdrawn by the second participant.

46. The construction project funding system of claim 30 wherein the first participant may select the timing of the payment.

47. The construction project funding system of claim 46 wherein the timing of the payment affects the amount of the payment.

48. A computer-based system for managing and facilitating accelerated payments, associated with a construction project, that are funded through a third-party funding source, the system comprising:
means for receiving an approval of a request for a payment, the approval being based on a review of a first project metric;
means for transmitting an accelerated payment instruction to the third-party funding source;
means for making available a second project metric to the third-party funding source; and
means for receiving a funding approval from the third-party funding source confirming that an accelerated payment for a requested payment amount will be funded by the third-party funding source.

49. A construction project funding system for processing accelerated payments associated with a construction project that are funded through a third-party funding source, the system comprising:
means for receiving, from a first participant associated with the construction project, a request for a payment for services or materials provided in connection with the construction project, the request for payment including a requested payment amount; and
means for receiving an approval of the request for payment from a second participant associated with the construction project, wherein the approval is based on a review of a first project metric by the second participant, and wherein the approval by the second participant cannot be revoked by the second participant and creates an obligation that the second participant satisfy the request for payment by providing repayment to the third-party funding source.
